(19) United States
(12) Patent Application Publication
(10) Pub. No.: US 2026/0262093 A1
(43) Pub. Date: Sep. 3, 2026

(54) RAR ENHANCEMENT FOR INTER-CELL MULTI-TRP SYSTEMS

(71) Applicant: QUALCOMM Incorporated, San Diego, CA (US)

(72) Inventors: Shaozhen GUO, Beijing (CN); Mostafa KHOSHNEVISAN, San Diego, CA (US); Jing SUN, San Diego, CA (US); Xiaoxia ZHANG, San Diego, CA (US); Fang YUAN, Beijing (CN); Yan ZHOU, San Diego, CA (US); Tao LUO, San Diego, CA (US); Peter GAAL, San Diego, CA (US)

(21) Appl. No.: 18/876,106

(22) PCT Filed: Jul. 27, 2022
(86) PCT No.: PCT/CN2022/108183

§ 371 Date: Dec. 17, 2024

(51) Int. Cl. H04W 74/0833; H04L 5/00; H04W 72/231

(52) U.S. Cl. CPC H04W 74/0833; H04L 5/0053; H04W 72/231

(57) ABSTRACT

A user equipment (UE) may be configured to receive a first RRC configuration including a first configuration of a first PCI and a second PCI from a serving cell. The serving cell may be associated with a first PCI and an additional cell may be associated with the second PCI different from the first PCI. The UE may be configured to receive a PDCCH order from a network node including an indication of a PRACH transmission associated with the second PCI. The UE may be configured to transmit the PRACH transmission associated with the second PCI during a PRACH occasion. The UE may be configured to monitor at least one first CSS in a first CORESET during a RAR window associated with the second PCI. The RAR window may be based on a time location of the PRACH occasion.

### TECHNICAL FIELD

The present disclosure relates generally to communication systems, and more particularly, to a multiple transmission-reception point (TRP) system having additional PCIs configured to transmit random access responses (RARs).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may have a memory and at least one processor coupled to the memory at a user equipment (UE). Based at least in part on information stored in the memory, the at least one processor may be configured to receive a first radio resource control (RRC) configuration including a first configuration of a first physical cell identifier (ID) (PCI) and a second PCI from a serving cell. The serving cell may be associated with a first PCI and an additional cell may be associated with the second PCI different from the first PCI. Based at least in part on information stored in the memory, the at least one processor may be configured to receive a physical downlink control channel (PDCCH) order from a network node including an indication of a physical random access channel (PRACH) transmission associated with the second PCI. Based at least in part on information stored in the memory, the at least one processor may be configured to transmit the PRACH transmission associated with the second PCI during a PRACH occasion. Based at least in part on information stored in the memory, the at least one processor may be configured to monitor at least one first common search space (CSS) in a first control resource set (CORESET) during a random access response (RAR) window associated with the second PCI. The RAR window may be based on a time location of the PRACH occasion.

In an aspect of the disclosure, a method, a computer-readable medium, and an apparatus are provided. The apparatus may have a memory and at least one processor coupled to the memory at a network entity. Based at least in part on information stored in the memory, the at least one processor may be configured to receive a configuration of at least one first CSS in a first CORESET associated with a second PCI from a serving cell. The serving cell may be associated with a first PCI different from the second PCI. The network node may be associated with the second PCI. Based at least in part on information stored in the memory, the at least one processor may be configured to transmit a PDCCH order including an indication of a PRACH transmission to a UE. Based at least in part on information stored in the memory, the at least one processor may be configured to receive the PRACH transmission associated with the second PCI from the UE during a PRACH occasion. Based at least in part on information stored in the memory, the at least one processor may be configured to transmit, in response to receiving the PRACH transmission, a RAR message during a RAR window associated with the second PCI to the UE. The RAR window may be based on a time location of the PRACH occasion.

To the accomplishment of the foregoing and related ends, the one or more aspects include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a diagram illustrating an example of a wireless communications system having a plurality of network nodes configured to communicate with a UE, in accordance with various aspects of the present disclosure.

FIG. 5 is a connection flow diagram illustrating an example of a wireless communications system having a plurality of network nodes configured to trigger a random access response (RAR) to a UE, in accordance with various aspects of the present disclosure.

FIG. 6 is a connection flow diagram illustrating another example of a wireless communications system having a plurality of network nodes configured to trigger a RAR to a UE, in accordance with various aspects of the present disclosure.

FIG. 7 is a connection flow diagram illustrating another example of a wireless communications system having a plurality of network nodes configured to trigger a RAR to a UE, in accordance with various aspects of the present disclosure.

FIG. 8 is a connection flow diagram illustrating another example of a wireless communications system having a plurality of network nodes configured to trigger a RAR to a UE, in accordance with various aspects of the present disclosure.

FIG. 9 is a flowchart of a method of wireless communication.

FIG. 10 is another flowchart of a method of wireless communication.

FIG. 11 is a diagram illustrating an example of a hardware implementation for an example apparatus and/or network entity.

FIG. 12 is a diagram illustrating an example of a hardware implementation for an example network entity.

### DETAILED DESCRIPTION

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission-reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

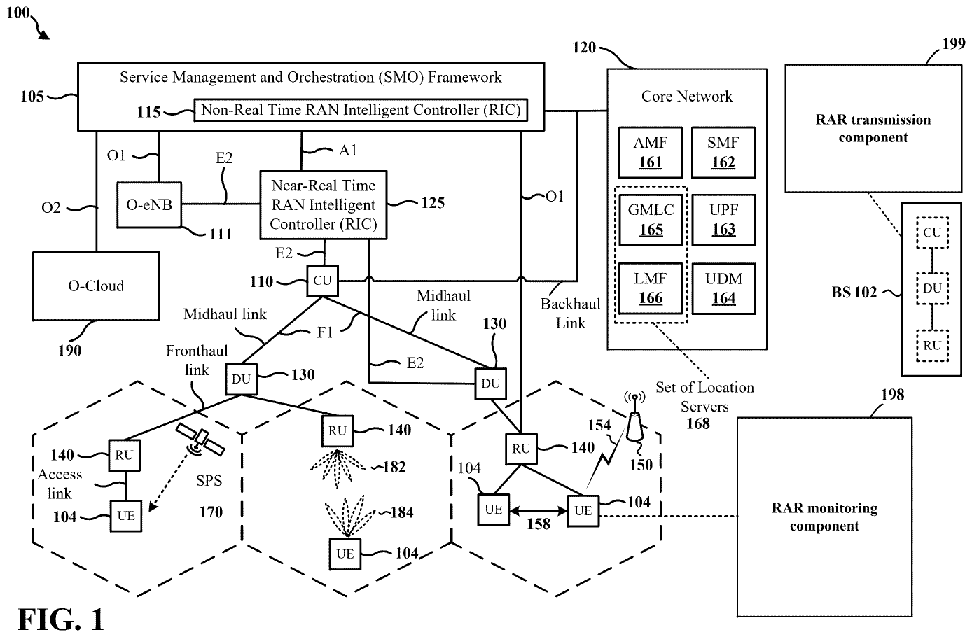

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a RAR monitoring component 198 configured to receive a first RRC configuration including a first configuration of a first PCI and a second PCI from a serving cell. The serving cell may be associated with a first PCI and an additional cell may be associated with the second PCI different from the first PCI. The RAR monitoring component 198 may be configured to receive a PDCCH order from a network node including an indication of a PRACH transmission associated with the second PCI. The RAR monitoring component 198 may be configured to transmit the PRACH transmission associated with the second PCI during a PRACH occasion. The RAR monitoring component 198 may be configured to monitor at least one first CSS in a first CORESET during a RAR window associated with the second PCI. The RAR window may be based on a time location of the PRACH occasion. In certain aspects, a base station 102 may have a RAR transmission component 199 configured to receive a configuration of at least one first CSS in a first CORESET associated with a second PCI from a serving cell. The serving cell may be associated with a first PCI different from the second PCI. The network node may be associated with the second PCI. The RAR transmission component 199 may be configured to transmit a PDCCH order including an indication of a PRACH transmission to a UE. The RAR transmission component 199 may be configured to receive the PRACH transmission associated with the second PCI from the UE during a PRACH occasion. The RAR transmission component 199 may be configured to transmit, in response to receiving the PRACH transmission, a RAR message during a RAR window associated with the second PCI to the UE. The RAR window may be based on a time location of the PRACH occasion. Although the following description may be focused on 5G NR, the concepts described herein may be applicable to other similar areas, such as LTE, LTE-A, CDMA, GSM, and other wireless technologies.

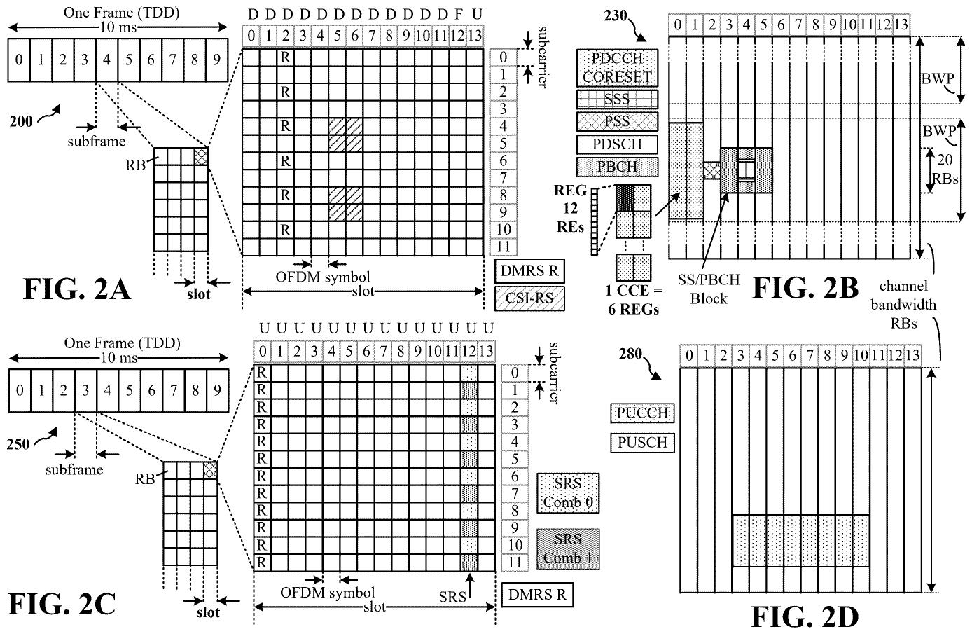

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

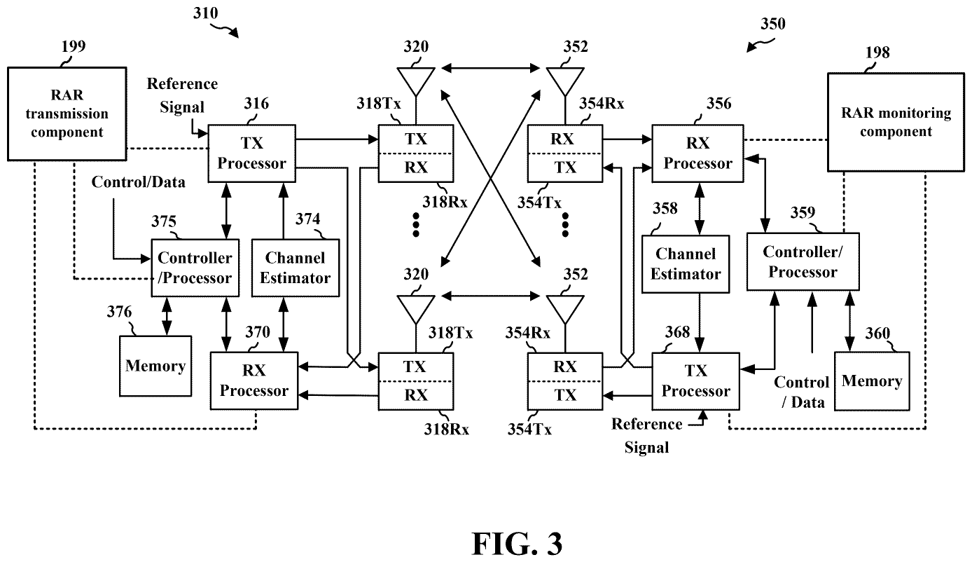

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the RAR monitoring component 198 of FIG. 1.

At least one of the TX processor 316, the RX processor 370, and the controller/processor 375 may be configured to perform aspects in connection with the RAR transmission component 199 of FIG. 1.

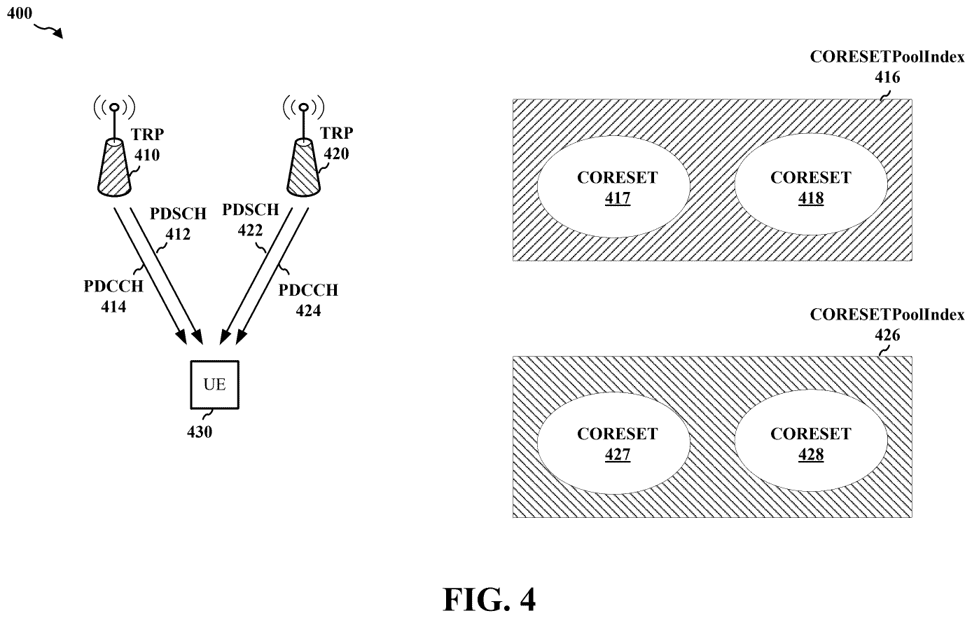

FIG. 4 is a diagram 400 illustrating an example of a wireless communications system having a TRP 410, a TRP 420, and a UE 430. A network node, such as the base station 102 in FIG. 1, may communicate with the UE 430 via either TRP 410 or TRP 420. Each of the TRP 410 and the TRP 420 may be configured to transmit DCI to the UE 430 providing a multi-DCI based design for multi-TRP (mTRP) transmission. In one aspect, a first DCI transmitted from TRP 410 may be transmitted as PDCCH 414 to the UE 430. The first DCI of the PDCCH 414 may schedule a PDSCH 412 from the TRP 410 to the UE 430. A second DCI transmitted from TRP 420 may be transmitted as PDCCH 414 to the UE 430. The DCI of the PDCCH 414 may schedule a PDSCH 412 from the TRP 410 to the UE 430.

In some aspects, the TRP 410 and the TRP 420 may be transparent to the UE 430. In other words, the UE 430 may not be able to differentiate between transmissions from the TRP 410 and the TRP 420. The UE 430 may differentiate between one transmission and the next using a CORESET value or a CORESETPoolIndex value associated with a transmission. In other words, a CORESETPoolIndex value may allow the UE 430 to determine that the PDSCH 412 is from TRP 410, the PDSCH 422 is from TRP 420, the PDCCH 414 is from TRP 410, or the PDCCH 424 is from TRP 420. In another aspect, the UE 430 may not be able to differentiate between transmissions from different TRPs, but may be able to differentiate between transmissions associated with one CORESET value and another CORESET value, or between transmissions associated with one CORESETPoolIndex and another CORESETPoolIndex.

Each CORESET of the UE 430 may be configured with a CORESETPoolIndex value. For example, the UE 430 may be configured (e.g., RRC configured) to have the first CORESETPoolIndex 416 and the second CORESETPoolIndex 426. The UE 430 may be configured by a configuration for PDCCH that are received by the UE 430, which may include different values of CORESETPoolIndex in CORESETs for the active BWP of a serving cell for the UE 430. A serving cell may be a network node that configures a UE using an RRC configuration. An RRC configuration may include a configuration of a PCI associated with the serving cell (e.g., serving cell PCI) and a PCI associated with an additional cell, or a non-serving cell (e.g., additional cell PCI). The configuration may be, for example, a serving cell configuration including a serving cell index, a BWP ID, and a set of additional PCIs, each with an additional PCI index and an additional PCI value. A serving cell may be a special cell (SpCell). If the UE configured with carrier aggregation (CA), the UE may have one serving cell that includes its primary cell. If the UE is configured with CA, the UE may have a set of serving cells that includes its primary cell and a set of secondary cells. The primary cell of a set of serving cells may be referred to as the special cell (SpCell).

The first CORESETPoolIndex 416 and the second CORESETPoolIndex 426 may be differentiated by a numerical value, for example the first CORESETPoolIndex 416 may be assigned a numerical value of 0 and the second CORESETPoolIndex 426 may be assigned a numerical value of 1. Each of the first CORESETPoolIndex 416 and the second CORESETPoolIndex 426 may also be associated with a TRP. For example, the first CORESETPoolIndex 416 may be associated with TRP 410 and the second CORESETPoolIndex 426 may be associated with TRP 420. The configured CORESETS of the UE 430 may be associated with one of the CORESETPoolIndex groups. For example, the CORESET 417 and the CORESET 418 may be associated with the first CORESETPoolIndex 416 and the CORESET 427 and the CORESET 428 may be associated with the second CORESETPoolIndex 426. Each of the CORESETS may be assigned a numerical value, for example the CORESET 417 may be assigned a numerical value of 1, the CORESET 418 may be assigned a numerical value of 2, the CORESET 427 may be assigned a numerical value of 3, and the CORESET 428 may be assigned a numerical value of 4. In response to the CORESET of a transmission having a CORESET value of CORESET 417, the UE 430 may associate the transmission with the first CORESETPoolIndex 416. In response to the CORESET of a transmission having a CORESET value of CORESET 418, the UE 430 may associate the transmission with the first CORESETPoolIndex 416. The first CORESETPoolIndex 416 may be associated with TRP 410. In response to the CORESET of a transmission having a CORESET value of CORESET 427, the UE 430 may associate the transmission with the second CORESETPoolIndex 426. In response to the CORESET of a transmission having a CORESET value of CORESET 428, the UE 430 may associate the transmission with the second CORESETPoolIndex 426. The second CORESETPoolIndex 426 may be associated with TRP 420.

Each TRP in a network may have the same PCI or different PCI. A PCI may be an identifier of a cell, such as a serving cell, an SpCell, or an additional cell. An additional cell may also be referred to as a non-serving cell, or a cell that does not configure the UE using an RRC configuration. Communication between a UE and an additional cell may be scheduled by a serving cell, such as an SpCell, a primary cell, or a secondary cell of the UE. The PCI may be used to identify one cell versus another cell on a PHY layer, and may be used for DL synchronization. In one aspect, if the TRP 410 and the TRP 420 are intra-cell TRP, such as different panels of the same cell or different panels of the same base station, the PCI for TRP 410 and TRP 420 may be the same. In another aspect, if the TRP 410 and the TRP 420 are inter-cell TRP, such as different cells or different base stations, the PCI for TRP 410 and TRP 420 may be the different from one another. While a network system may have a plurality of TRP transmitting data to the same UE, such as TRP 410 and TRP 420 transmitting to the UE 430, the UE 430 may be aware of one PCI—the PCI acquired by the UE during a cell search- and may not be aware of any other PCI.

A UE, such as the UE 430 or the UE 104 in FIG. 1, may be configured (e.g., RRC configured) with a list of candidate transmission configuration indication (TCI) states for quasi co-location (QCL) indication. For example, one QCL location may have a list of up to 128 TCI states. The TCI states may be used to configure the TCI states CORESET, non-zero power (NZP) channel state information (CSI) reference signal (NZP-CSI-RS) resources, physical uplink control channel (PUCCH) resources, or sounding reference signal (SRS) resources. A network node may transmit a medium access control (MAC) control element (MAC-CE) to the UE to activate a number of RRC configured TCI states. Such a MAC-CE may be referred to as a TCI-activation MAC-CE. In one aspect, 2^{N} TCI states out of M TCI states may be activated via MAC-CE for a PDSCH QCL indication for one CORESETPoolIndex of the UE. N bits in DCI may also or alternatively be used to dynamically indicate a TCI state for a PDSCH transmission. For example, where N=3, DCI may indicate one out of eight TCI states. The UE may associate a PDSCH with the CORESETPoolIndex value of the CORESET in which DCI is received. In another aspect, one TCI state out of M TCI states may be activated via MAC-CE for a PDCCH QCL indication for one CORESETPoolIndex of the UE.

In some aspects, a UE may have a capability to have additional RRC-configured PCIs for a serving cell or component carrier (CC). For example, an RRC configuration may configure a number of additional PCIs to be 1, 2, 3, 4, 5, 6, or 7. An additional cell may be a cell that is not a serving cell of the UE. A serving cell may configure a UE using RRC configuration, but an additional cell may not configure the UE using RRC configuration. Each serving cell may be configured with multiple additional PCIs for inter-cell mDCI mTRP. A UE may report its capability to have additional RRC-configured PCIs for a CC as a UE capability of a maximum number of additional RRC-configured PCIs per CC that the UE may be capable of supporting. In some aspects, a UE may be configured to report more than one maximum number of additional RRC-configured PCIs per CC, to allow for different UE capability numbers for different UE environments. A UE environment may change, for example, based on additional SSB time domain positions and/or periodicity with respect to a serving cell SSB time domain positions and/or periodicity. In one aspect, a UE may report a first UE capability as a maximum number of additional RRC-configured PCIs for a CC if each configuration of SSB time domain positions and periodicity of the additional PCIs are the same as SSB time domain positions and periodicity of the serving cell PCI. A UE may report a second UE capability as a maximum number of additional RRC-configured PCIs for a CC if a configuration of SSB time domain positions and periodicity of the additional PCIs are not same as SSB time domain positions and periodicity of the serving cell PCI. The UE capability may be reported to differentiate between frequency ranges, for example FR1 and FR2 differentiation. The UE may assume that one or more attributes of one or more of the additional PCIs are the same as the attributes for the serving cell PCI. In one aspect, a UE may assume that at least one of a center frequency, an SCS, or an SFN offset may be the same for SSBs from the serving cell and the configured SSBs for additional PCI different from the serving cell for inter-cell mTRP systems. An RRC configuration may have one or more indicators that indicate attributes that a TCI state or a QCL is associated with. The RRC configuration may not have a PCI value, but may refer to attributes associated with a serving cell PCI and attributes associated with one or more non-serving cell PCIs. Non-serving cell PCIs may be referred to as additional PCIs. An RRC configuration may have, for example, an indicator of an SSB of the serving cell, a PCI of the serving cell, an indicator of an SSB of one or more additional PCIs, and a PCI of one or more additional PCIs.

A serving cell PCI may be associated with one or more active TCI states. An additional PCI may be associated with an active TCI state. In other words, an active TCI state may be associated with a serving cell PCI, and zero or one additional PCIs. Different PCIs may be associated with different values of CORESETPoolIndex as well. A first PCI may be associated with a set of activated TCI states for PDSCH or PDCCH and a first CORESETPoolIndex, and a second PCI may be associated with a set of activated TCI states for PDSCH or PDCCH and a second CORESETPoolIndex. In other words, a first PCI may be associated with a first TRP and a second PCI may be associated in a second TRP.

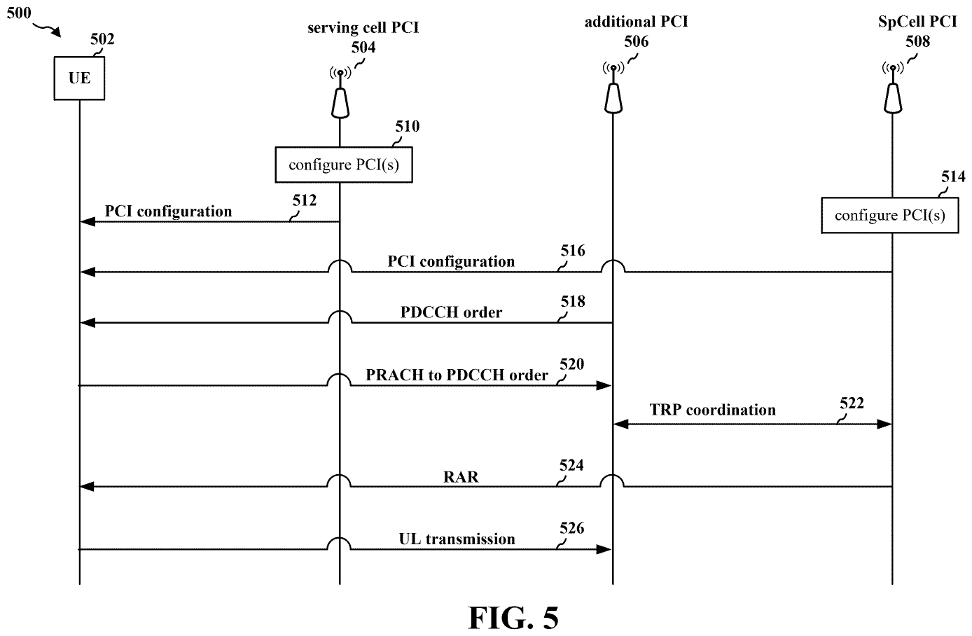

In FIG. 5, a connection flow diagram 500 illustrates an example of a wireless communications system having an additional PCI 506 configured to transmit a PDCCH order 518 to a UE 502. The serving cell PCI 504 of the UE 502 may be different than the special cell (SpCell) PCI 508 of the UE 502. As used herein, a PCI may be a network node associated with a PCI. The serving cell PCI 504 may be a network node (e.g., a TRP) associated with the serving cell PCI of the UE 502, the additional PCI 506 may be a network node associated with the additional PCI of the UE 502, and the SpCell PCI may be a network node associated with the special cell PCI of the UE 502. At 510, the serving cell PCI 504 may configure one or more PCIs for the UE 502, and may output a PCI configuration 512 to the UE 502. The UE 502 may receive the PCI configuration 512 of one or more PCIs for the UE 502 from the serving cell PCI 504. The PCI configuration 512 may configure, for example, the serving cell PCI 504 and the additional PCI 506 for the UE 502. At 514, the SpCell PCI 508 may configure one or more PCIs for the UE 502, and may output a PCI configuration 516 to the UE 502. The UE 502 may receive the PCI configuration 516 of one or more PCIs for the UE 502 from the SpCell PCI 508. The PCI configuration 516 may configure, for example, the SpCell PCI 508 and the additional PCI 506 for the UE 502. The PCI configuration 516 may also configure additional PCIs for the SpCell which are different from the one or more PCIs in PCI configuration 512. The PCI configuration 512 or the PCI configuration 516 may be, for example, an RRC configuration of the UE 502.

The additional PCI 506 may transmit a PDCCH order 518 to the UE 502, triggering the PRACH transmission 520 to the PDCCH order 518. In some example, the PDCCH order 518 may be transmitted from serving cell PCI 504 or SpCell PCI 508 to triggering the PRACH transmission 520 (which is not shown in the figure). The additional PCI 506 may measure a timing advance (TA) for the UE 502 based on the PRACH transmission 520. In some aspects, the UE 502 may not be configured to monitor common search space (CSS) in a CORESET if the active TCI state is associated with a PCI different from the serving cell PCI 504. In other words, the UE 502 may not be able to receive CSS in a CORESET if the additional PCI 506 transmits the random access response (RAR) 524. A CSS may be a common search space of resources that the UE monitors during a time period to identify and process DL signals. A RAR may be a message received by a UE during UL synchronization that includes information used by the UE to synchronize with a cell, such as timing advance (TA) information.

The additional PCI 506 may be configured to communicate with the SpCell PCI 508 to transmit the measured TA using the TRP coordination 522 between the additional PCI 506 and the SpCell PCI 508. The additional PCI 506 may output the measured TA using the TRP coordination 522. The SpCell PCI 508 may obtain the measured TA using the TRP coordination 522. The SpCell PCI 508 may output the random access response (RAR) 524 to the UE 502. The UE 502 may receive the RAR 524 from the SpCell PCI. The UE 502 may be configured to monitor CSS in a CORESET if the active TCI state is associated with the SpCell PCI 508. The UE 502 may transmit an UL transmission 526 to the additional PCI using the measured TA.

While inter-TRP coordination may allow the UE 502 to receive the RAR associated with additional PCI 506 by using the TRP coordination 522 between the additional PCI 506 and the SpCell PCI 508, if the backhaul between the additional PCI 506 and the SpCell PCI 508 is not ideal, there may be a large latency for the additional PCI 506 to pass along the measured TA to the SpCell PCI 508 using the TRP coordination 522. The latency may prevent the UE 502 from receiving the RAR 524 within the RAR window, as the RAR window may start shortly after the PRACH transmission 520 ends.

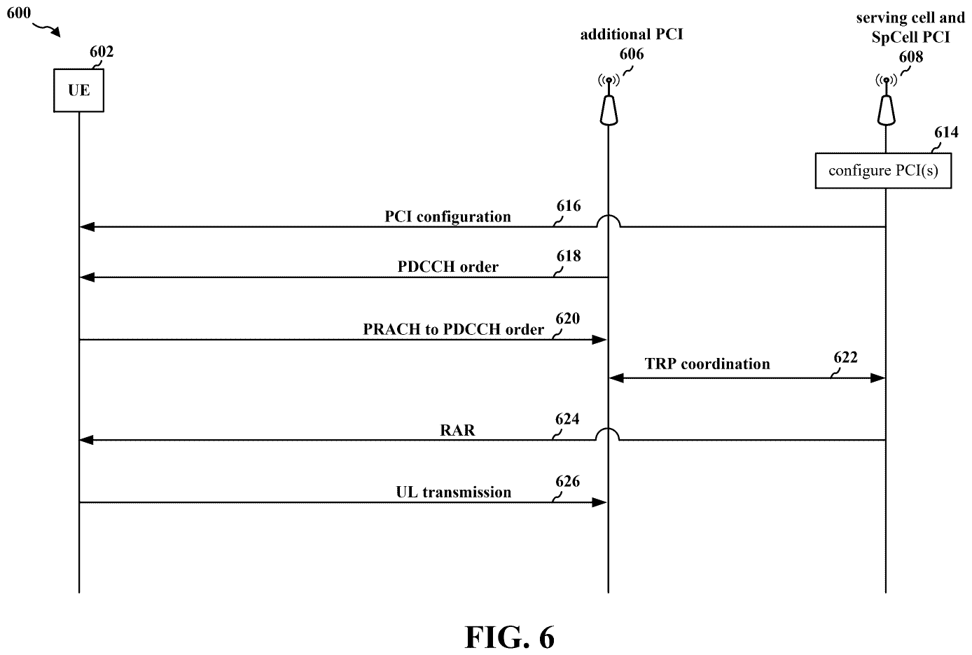

In FIG. 6, a connection flow diagram 600 illustrates an example of a wireless communications system having an additional PCI 606 configured to transmit a PDCCH order 618 to a UE 602. The serving cell PCI of the UE 602 may be the same as the SpCell PCI 608 of the UE 602. At 614, the SpCell PCI 608 may configure one or more PCIs for the UE 602, and may output a PCI configuration 616 to the UE 602. The UE 602 may receive the PCI configuration 616 of one or more PCIs for the UE 602 from the SpCell PCI 608. The PCI configuration 616 may configure, for example, the SpCell PCI 608 and the additional PCI 606 for the UE 602. The PCI configuration 616 may be, for example, an RRC configuration of the UE 602.

The additional PCI 606 may transmit a PDCCH order 618 to the UE 602, triggering the PRACH transmission 620 to the PDCCH order 618. In some example, the PDCCH order 618 may be transmitted from serving cell PCI or SpCell 608 to triggering the PRACH transmission 620 (which is not shown in the figure). The additional PCI 606 may measure a timing advance (TA) for the UE 602 based on the PRACH transmission 620. In some aspects, the UE 602 may still not be configured to monitor CSS in a CORESET if the active TCI state is associated with a PCI different from the SpCell PCI 608. In other words, the UE 602 may not be able to receive CSS in a CORESET if the additional PCI 606 transmits the RAR 624. To overcome this limitation, the additional PCI 606 may be configured to communicate with the SpCell PCI 608 to transmit the measured TA using the TRP coordination 622 between the additional PCI 606 and the SpCell PCI 608. The additional PCI 606 may output the measured TA using the TRP coordination 622. The SpCell PCI 608 may obtain the measured TA using the TRP coordination 622. The SpCell PCI 608 may output the random access response (RAR) 624 to the UE 602. The UE 602 may receive the RAR 624 from the SpCell PCI. The UE 602 may be configured to monitor CSS in a CORESET if the active TCI state is associated with the SpCell PCI 608. The UE 602 may transmit an UL transmission 626 to the additional PCI using the measured TA.

While inter-TRP coordination may allow the UE 602 to receive the RAR from the additional PCI 606 by using the TRP coordination 622 between the additional PCI 606 and the SpCell PCI 608, if the backhaul between the additional PCI 606 and the SpCell PCI 608 is not ideal, there may be a large latency for the additional PCI 606 to pass along the measured TA to the SpCell PCI 608 using the TRP coordination 622. The latency may prevent the UE 602 from receiving the RAR 624 within the RAR window, as the RAR window may start shortly after the PRACH transmission 620 ends.

To reduce the latency of passing off a measured TA using the TRP coordination 622 in FIG. 6 or the TRP coordination 522 in FIG. 5, an additional PCI may be configured to transmit a RAR transmission to the UE, and the UE may be configured to monitor CSS in a CORESET associated with the additional PCI.

In one aspect, a UE may be configured to receive a configuration of a second PCI (e.g., an additional PCI) from a serving cell associated with a first PCI (e.g., the serving cell PCI or an SpCell PCI) different from the second PCI. The UE may be configured to receive a PDCCH order from a network node including an indication of a PRACH transmission associated with the second PCI. The PDCCH order may be transmitted from the additional PCI, the serving cell PCI, or the special cell PCI. The UE may be configured to transmit the PRACH transmission associated with the second PCI in/during a PRACH occasion. The UE may be configured to monitor at least one first CSS in a first CORESET, in response to the PRACH transmission, during a RAR window associated with the second PCI. The RAR window may be based on a time location of the PRACH occasion. For example, the RAR window may be scheduled as a number of symbols after a last symbol of a PRACH occasion. A PRACH occasion may be a period of time scheduled by a serving cell for the UE to transmit a PRACH transmission using resources associated with the PRACH transmission. A PRACH occasion may also be referred to as a PRACH window.

In another aspect, a network node (e.g., a TRP of an additional or the serving cell PCI), may be configured to transmit a configuration of at least one first CSS in a first CORESET associated with a second PCI (e.g., the additional PCI) from a serving cell associated with a first PCI (e.g., the serving cell PCI or an SpCell PCI) different from the second PCI. The network node may be configured to transmit a PDCCH order including an indication of a PRACH transmission to a UE. The network node may be configured to receive the PRACH transmission associated with the second PCI in a PRACH occasion. The network node may be configured to transmit a RAR message in response to the PRACH reception during a RAR window associated with the second PCI to the UE. The RAR window may be based on a time location of the PRACH occasion.

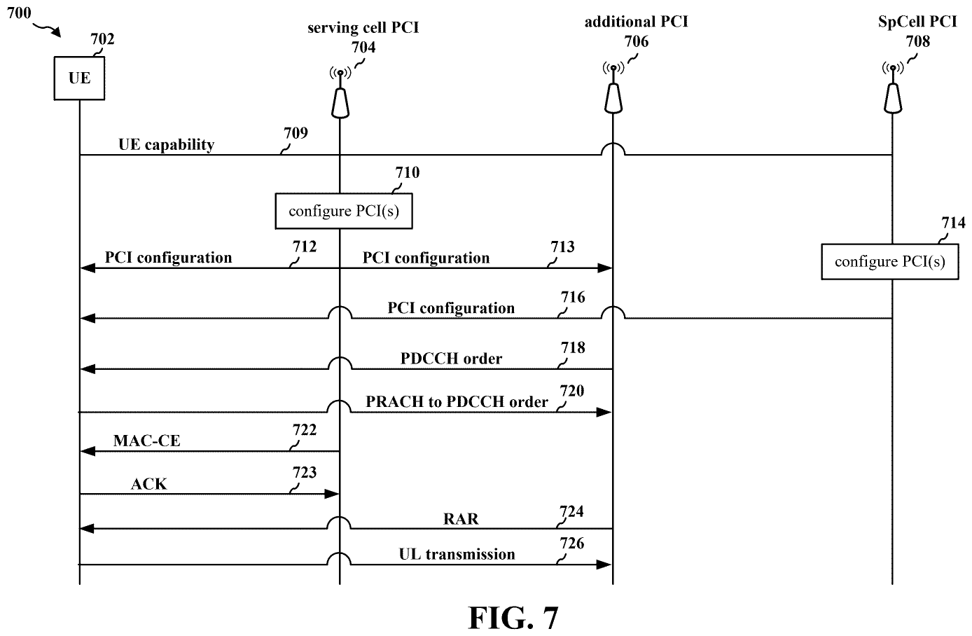

In FIG. 7, a connection flow diagram 700 illustrates an example of a wireless communications system having an additional PCI 706 configured to transmit a PDCCH order 718 to a UE 702. The serving cell PCI 704 of the UE 702 may be different than the SpCell PCI 708 of the UE 702. The serving cell PCI 704 may be a network node (e.g., a TRP) associated with the serving cell PCI of the UE 702, the additional PCI 706 may be a network node associated with the additional PCI of the UE 702, and the SpCell PCI 708 may be a network node associated with the special cell PCI of the UE 702. At 710, the serving cell PCI 704 may configure one or more PCIs for the UE 702, and may output a PCI configuration 712 to the UE 702. The UE 702 may receive the PCI configuration 712 of one or more PCIs for the UE 702 from the serving cell PCI 704. The PCI configuration 712 may configure, for example, the serving cell PCI 704 and the additional PCI 706 for the UE 702. At 714, the SpCell PCI 708 may configure one or more PCIs for the UE 702, and may output a PCI configuration 716 to the UE 702. The UE 702 may receive the PCI configuration 716 of one or more PCIs for the UE 702 from the SpCell PCI 708. The PCI configuration 716 may configure, for example, the SpCell PCI 708 and the additional PCI 706 for the UE 702. The PCI configuration 712 or the PCI configuration 716 may be, for example, an RRC configuration of the UE 702.

The additional PCI 706 may transmit a PDCCH order 718 to the UE 702, triggering the PRACH transmission 720 to the PDCCH order 718. In some example, the PDCCH order may be transmitted from the serving cell PCI 704 or from SpCell PCI 708 which is not shown here. The additional PCI 706 may measure a timing advance (TA) for the UE 702 based on the PRACH transmission 720. In some aspects, the UE 702 may be configured to monitor CSS in a CORESET if the active TCI state is associated with a PCI different from the serving cell PCI 704. The CSS may be, for example, NR Type-1 CSS. The UE 702 may be configured to monitor CSS in a CORESET if the active TCI state is associated with the additional PCI 706. The UE 702 may be configured to monitor CSS in the CORESET if the active TCI state is associated with the additional PCI 706 in response to a MAC-CE received from the serving cell PCI 704. The serving cell PCI 704 may output the MAC-CE 722 to the UE 702. The UE 702 may receive the MAC-CE 722. The UE 702 may respond with an ACK 723 to the serving cell PCI 704. The serving cell PCI 704 may obtain the ACK 723 from the UE 702. The additional PCI 706 may transmit RAR message to the UE in response to receiving the PRACH transmission 720. The UE 702 may transmit an UL transmission 726 to the additional PCI using the indicated TA in RAR. While one additional PCI 706 is shown in connection flow diagram 700, more additional PCIs may be configured with the UE 702 in other embodiments, as the PCI configuration 712 may include RRC configuration for a plurality of PCIs, depending upon the UE capability of the UE 702. In some aspects, the UE 702 may be configured to process the RAR 724 in response to a failure to receive the MAC-CE 722 that activates a TCI state associated with the additional PCI 706.

In one aspect, one CSS set may be configured in a CORESET and may be applied for the SpCell PCI 708 and the additional PCI 706. The configuration may be, for example, the PCI configuration 712 configured by the serving cell PCI 704 at 710, or the PCI configuration 716 configured by the SpCell PCI 708 at 714. The active TCI state of the CORESET in which the CSS set is configured may be associated with the serving cell PCI 704, the additional PCI 706, or the SpCell PCI 708 based on one or more indicators of the MAC-CE 722. In some aspects, the UE 702 may be configured to monitor the CSS in a CORESET if the active TCI state is associated with the additional PCI 706 within the RAR window associated with the additional PCI 706 if one or more of the following conditions are satisfied: (a) the additional PCI 706 is configured by the serving cell PCI 704 at 710, (b) the additional PCI 706 is configured by the SpCell PCI 708 at 714, and (c) the additional PCI 706 is associated with the same CORESETPoolIndex or timing advance group (TAG) identifier (ID) for the serving cell PCI 704 and the SpCell PCI 708. In some aspects, the UE 702 may be configured to monitor the CSS in a CORESET if the active TCI state is associated with the additional PCI 706 within the RAR window associated with the additional PCI 706 if each of the three conditions are satisfied or if condition (b) is satisfied. The UE 702 may determine that the additional PCI 706 is configured by the serving cell PCI 704 at 710 by receiving the PCI configuration 712 that configures the additional PCI 706 from the serving cell PCI 704. The UE 702 may determine that the additional PCI 706 is configured by the SpCell PCI 708 at 714 by receiving the PCI configuration 716 that configures the additional PCI 706 from the SpCell PCI 708.

The UE 702 may be configured to monitor CSS in a CORESET associated with the additional PCI 706 if the additional PCI 706 that the active TCI state of the CORESET is associated with is the same as the additional PCI 706 to which the PRACH transmission 720 or the RAR window of the RAR 724 corresponds. In other words, in response to the PRACH transmission 720 having a preamble ID that is indicated by the PDSCH of the RAR 724, the UE 702 may monitor CSS in a CORESET associated with the additional PCI 706. The PRACH transmission 720 and the RAR 724 may correspond with one another via the preamble ID indicated by the RAR PDSCH.

The UE 702 may transmit a UE capability 709 to at least one of the serving cell PCI 704 or the SpCell PCI 708. In some aspects, the UE 702 may transmit a UE capability 709 to both the serving cell PCI 704 and the SpCell PCI 708. The UE capability may have an indicator that indicates whether the UE 702 may monitor CSS in a CORESET if the active TCI state is associated with the additional PCI 706. In some aspects, the UE capability of the UE 702 may be configured in an RRC configuration, for example by PCI configuration 712 or the PCI configuration 716. The RRC configuration may be applied to the additional PCI 706 and no other additional PCIs, or to a set of additional PCIs, to which the additional PCI 706 belongs.

In some aspects, the UE 702 may be configured to determine whether to monitor CSS in a CORESET if the active TCI state is associated with the SpCell PCI 708. In one aspect, the UE 702 may be configured to not monitor CSS in the RAR window associated with the additional PCI 706 in a CORESET if the active TCI state is associated with the SpCell PCI 708. In another aspect, the UE 702 may be configured to monitor CSS in the RAR window associated with the additional PCI 706 in a CORESET if the active TCI state is associated with the SpCell PCI 708. In another aspect, the UE 702 may be configured to monitor CSS in the RAR window associated with the additional PCI 706 in a CORESET based on an RRC configuration, such as the PCI configuration 712 or the PCI configuration 716. In one aspect, the RRC configuration may enable or disable CSS monitoring in the RAR window associated with a set of additional PCIs, which the additional PCI 706 is a part of. In another aspect, the RRC configuration may enable or disable CSS monitoring in the RAR window associated with the additional PCI 706 based on the configuration of the specific PCI value of the additional PCI 706. Each additional PCI 706 may be enabled or disabled based on individual triggers, such as MAC-CE tailored for each additional PCI. In one aspect, the UE 702 may be configured to monitor CSS in the RAR window associated with the additional PCI 706 when the active TCI state is associated with the SpCell PCI 708, but may not be configured to monitor CSS in the RAR window associated with a second additional PCI in a CORESET when the active TCI state is associated with the SpCell PCI 708. Such an aspect may be useful if there is a mixed backhaul scenario, for example when the backhaul between the SpCell PCI 708 and the additional PCI 706 has a good performance and the backhaul between the SpCell PCI 708 and the second additional PCI does not have a good performance.

In one aspect, a first CSS set may be configured in a CORESET for the SpCell PCI 708 and a second CSS set may be configured in the CORESET for the additional PCI 706. The configuration may be, for example, the PCI configuration 712 configured by the serving cell PCI 704 at 710, or the PCI configuration 716 configured by the SpCell PCI 708 at 714. The active TCI state of the CORESET in which the CSS set is configured may be associated with the additional PCI 706 based on one or more indicators of the MAC-CE 722. In some aspects, the CSS set in the CORESET may be configured for the UE 702 as a CSS set separate from the CSS set in the CORESET associated with the SpCell PCI 708 if one or more of the following conditions are satisfied: (a) the additional PCI 706 is configured by the serving cell PCI 704 at 710, (b) the additional PCI 706 is configured by the SpCell PCI 708 at 714, and (c) the additional PCI 706 is associated with the same CORESETPoolIndex or timing advance group (TAG) identifier (ID) for the serving cell PCI 704 and the SpCell PCI 708. The CSS set may be configured by the SpCell PCI 708 at 714. In some aspects, the CSS set in the CORESET may be configured for the UE 702 as a CSS set separate from the CSS set in the CORESET associated with the SpCell PCI 708 if each of the three conditions are satisfied, or if condition (b) above (the additional PCI 706 is configured by the SpCell PCI 708 at 714) is satisfied. The UE 702 may determine that the additional PCI 706 is configured by the serving cell PCI 704 at 710 by receiving the PCI configuration 712 that configures the additional PCI 706 from the serving cell PCI 704. The UE 702 may determine that the additional PCI 706 is configured by the SpCell PCI 708 at 714 by receiving the PCI configuration 716 that configures the additional PCI 706 from the SpCell PCI 708. In some aspects, the CSS set associated with the additional PCIs in the CORESET may be configured by the serving cell PCI 704 at 710 if the additional PCI 706 is configured by the serving cell PCI 704 in 710 but the SpCell PCI 708 is not configured with the same additional PCI 706.

In some aspects, the UE 702 may be predefined or configured to monitor the first CSS set (associated with the SpCell PCI 708) in a CORESET and not monitor the second CSS set (associated with the additional PCI 706) in the CORESET if the active TCI state of the CORESET is associated with the SpCell PCI 708. The UE 702 may be configured to monitor the second CSS set (associated with the additional PCI 706) in a CORESET and not monitor the first CSS set (associated with the SpCell PCI 708) in the CORESET if the active TCI state of the CORESET is associated with the additional PCI 706. The additional PCI may be the additional PCI to which the PRACH transmission 720 or the RAR 724 corresponds. In this aspect, the RAR for the PRACH transmission 720 associated with the serving cell PCI 704 may be transmitted from the SpCell PCI 708. The RAR for the PRACH transmission 720 associated with the additional PCI 706 may not be transmitted by a network node that is not the additional PCI 706. This configuration may be RRC configured to specifically the additional PCI 706 or to a set of additional PCIs to which the additional PCI 706 belongs. The UE capability 709 may have an indicator of whether the UE 702 may monitor the second CSS set (associated with the additional PCI 706) in a CORESET from the SpCell PCI 708. The UE capability 709 may have an indicator of whether the UE 702 may monitor the first CSS set (associated with the SpCell PCI 708) in a CORESET when the active TCI state of the CORESET is associated with the additional PCI 706.

In one aspect, the UE 702 may be configured to not expect the active TCI state of the CORESET to be associated with the serving cell PCI 704 or the SpCell PCI 708. In another aspect, the active TCI state of the CORESET may be associated with the serving cell PCI 704 or the additional PCI 706. For example, in one aspect, the UE 702 may be configured to monitor the CSS set associated with the additional PCI 706 in response to the active TCI state being associated with the additional PCI 706. The additional PCI 706 may be the same as the additional PCI with which the PRACH occasion or the RAR window corresponds. In such an aspect, the RAR 724 for the PRACH transmission 720 may be transmitted from the additional PCI 706 and not from the serving cell PCI 704 or the SpCell PCI 708. In another aspect, the UE 702 may be configured to monitor the CSS set associated with the additional PCI 706 in response regardless of whether the active TCI state is associated with the serving cell PCI 704 or the additional PCI 706. The additional PCI 706 may be the same as the additional PCI with which the PRACH occasion or the RAR window corresponds. In another aspect, the UE 702 may be configured to monitor both a first CSS set associated with a first CORESET on the SpCell PCI 708 and a second CSS set associated with a second CORESET on the serving cell PCI 704 associated with the additional PCI 706. The UE 702 may be configured to monitor the second CSS set in response to the active TCI state of the second CORESET being associated with the additional PCI 706, or to monitor the second CSS set regardless of whether the active TCI state of the second CORESET is associated with the serving cell PCI 704 or the additional PCI 706.

In some aspects, the UE 702 may be predefined or configured to monitor the first CSS set (associated with the SpCell PCI 708) in a CORESET and not monitor the second CSS (associated with the additional PCI 706) in the CORESET if the active TCI state of the CORESET is associated with the SpCell PCI 708. The UE 702 may be configured to monitor both the first CSS set (associated with the SpCell PCI 708) in a CORESET and the second CSS set (associated with the additional PCI 706) in the CORESET if the active TCI state of the CORESET is associated with the additional PCI 706. The additional PCI may be the additional PCI to which the PRACH transmission 720 or the RAR 724 corresponds. In this aspect, the RAR for the PRACH transmission 720 associated with the serving cell PCI 704 may be transmitted from the SpCell PCI 708 and not the additional PCI 706 or the serving cell PCI 704. The RAR for the PRACH transmission 720 associated with the additional PCI 706 may be transmitted by the SpCell PCI 708 or the additional PCI 706. This configuration may be RRC configured to specifically the additional PCI 706 or to a set of additional PCIs to which the additional PCI 706 belongs.

In some aspects, the UE 702 may be predefined or configured to monitor both the first CSS set (associated with the SpCell PCI 708) and the second CSS set (associated with the additional PCI 706) in a CORESET regardless of whether the active TCI state of the CORESET is associated with the additional PCI 706 or associated with the SpCell PCI 708. In this aspect, the RAR for the PRACH transmission 720 associated with the serving cell PCI 704 or the RAR for the PRACH transmission 720 associated with the additional PCI 706 may be transmitted by the SpCell PCI 708 or the additional PCI 706. This configuration may be RRC configured to specifically the additional PCI 706 or to a set of additional PCIs to which the additional PCI 706 belongs.

In one aspect, the UE 702 may be predefined or configured to monitor CSS associated with the additional PCI 706 in a first CORESET or monitor CSS associated with the SpCell PCI 708 in a second CORESET. In other words, the first CSS associated with the additional PCI 706 may be in a first CORESET and the second CSS associated with the SpCell PCI 708 may be in a second CORESET. The UE 702 may be configured to monitor the RAR in a RAR window based on the CORESET. The RAR window for a PRACH associated with the additional PCI 706 may be determined based on the CORESET that is configured with the additional CSS set or with the additional PCI 706. The RAR window for the PRACH transmission 720 associated with the additional PCI 706 may start at the first symbol of the earliest CORESET the UE 702 is configured to receive the CSS associated with the additional PCI 706, which is at least a fixed number of symbols after the last symbol of the PRACH occasion corresponding to the PRACH transmission 720. For a CORESET in which the CSS associated with the SpCell PCI 708 is configured, the UE 702 may not expect the active TCI state of the CORESET is associated with the additional PCI 706. A CSS of a CORESET may be associated with a PCI, such as the serving cell PCI 704 or the additional PCI 706. In one aspect, for the CORESET in which the CSS associated with the additional PCI 706 is configured, the UE 702 may not expect the active TCI state of the CORESET to be associated with the SpCell PCI 708. In another aspect, for the CORESET in which the CSS associated with the additional PCI 706 is configured, the active TCI state of the CORESET may be associated with the SpCell PCI 708 or the additional PCI 706.

In one aspect, the UE 702 may be predefined or configured to monitor CSS associated with the additional PCI 706 in a CORESET when the active TCI state of the CORESET is associated with the additional PCI 706. The RAR 724 may be transmitted from the additional PCI 706 and may not be transmitted from the serving cell PCI 704 or the SpCell PCI 708. This configuration may be RRC configured to specifically the additional PCI 706 or to a set of additional PCIs to which the additional PCI 706 belongs.

In another aspect, the UE 702 may be predefined or configured to monitor CSS associated with the additional PCI 706 in a CORESET regardless of whether the active TCI state of the CORESET is associated with the additional PCI 706 or the SpCell PCI 708. The RAR 724 may be transmitted from the SpCell PCI 708 or the additional PCI 706. This configuration may be RRC configured to specifically the additional PCI 706 or to a set of additional PCIs to which the additional PCI 706 belongs.

In another aspect, the UE 702 may be predefined or configured to monitor CSS associated with the additional PCI 706 in a first CORESET and CSS associated with the SpCell PCI 708 in a second CORESET. The UE 702 may monitor the CSS associated with the additional PCI 706 in a first CORESET if the active TCI state of the first CORESET is associated with the additional PCI 706. The UE 702 may monitor the CSS associated with the additional PCI 706 in a first CORESET regardless of whether the active TCI state of the first CORESET is associated with the SpCell PCI 708 or the additional PCI 706. The RAR 724 may be transmitted by the additional PCI 706 or the SpCell PCI 708. This configuration may be RRC configured to specifically the additional PCI 706 or to a set of additional PCIs to which the additional PCI 706 belongs.

In one aspect, if the additional PCI 706 is configured by the serving cell PCI 704 in 710 but the SpCell PCI 708 is not configured with the same additional PCI 706, the UE 702 may be predefined or configured to monitor CSS associated with the additional PCI 706 in a first CORESET on serving cell PCI 704 or monitor CSS associated with the SpCell PCI in a CORESET on SpCell. In other words, the first CSS associated with the additional PCI 706 may be in a first CORESET configured by serving cell PCI 704 and the second CSS associated with the SpCell PCI 708 may be in a second CORESET configured by the SpCell PCI 708. In one aspect, for a CORESET in which the CSS associated with the additional PCI 706 is configured, the UE 702 may not expect the active TCI state of the CORESET is associated with the serving cell PCI 704. In another aspect, for the CORESET in which the CSS associated with the additional PCI 706 is configured, the active TCI state of the CORESET may be associated with the serving cell PCI 704 or the additional PCI 706.

In one aspect, the UE 702 may be predefined or configured to monitor CSS associated with the additional PCI 706 in a CORESET on serving cell PCI 704 when the active TCI state of the CORESET is associated with the additional PCI 706. The RAR 724 may be transmitted from the additional PCI 706 and may not be transmitted from the serving cell PCI 704 or the SpCell PCI 708. This configuration may be RRC configured to specifically the additional PCI 706 or to a set of additional PCIs to which the additional PCI 706 belongs.

In another aspect, the UE 702 may be predefined or configured to monitor CSS associated with the additional PCI 706 in a CORESET on a serving cell PCI 704 regardless of whether the active TCI state of the CORESET is associated with the additional PCI 706 or the serving cell PCI 704. The RAR 724 may be transmitted from the serving cell PCI 704 or the additional PCI 706. This configuration may be RRC configured to specifically the additional PCI 706 or to a set of additional PCIs to which the additional PCI 706 belongs.

In another aspect, the UE 702 may be predefined or configured to monitor CSS associated with the additional PCI 706 in a first CORESET on the serving cell PCI 704 and CSS associated with the SpCell PCI 708 in a second CORESET on SpCell PCI 708. The UE 702 may monitor the CSS associated with the additional PCI 706 in a first CORESET on the serving cell PCI 704 if the active TCI state of the first CORESET is associated with the additional PCI 706. The UE 702 may monitor the CSS associated with the additional PCI 706 in a first CORESET on the serving cell PCI 704 regardless of whether the active TCI state of the first CORESET is associated with the serving cell PCI 704 or the additional PCI 706. The RAR 724 may be transmitted by the additional PCI 706 or the serving cell PCI 704. This configuration may be RRC configured to specifically the additional PCI 706 or to a set of additional PCIs to which the additional PCI 706 belongs.

In some aspects, the TCI activation MAC-CE 722 that indicates the active TCI state of the CORESET (in which the type-1 CSS is configured) is associated with the additional PCI may not be received by the UE 702 in time for the UE 702 to monitor the RAR window for the RAR 724. In some aspects, the UE may treat this as an error case. In other words, the network may be configured to ensure the RAR 724 can be transmitted from the additional PCI within the RAR window associated with the additional PCI 706 (e.g., by enabling such a feature via an RRC configuration or a MAC-CE). Therefore, the network may be configured to send the MAC CE to activate a TCI state associated with the additional PCI 706 for the CORESET in which the type-1 CSS is configured.

In one aspect, if the UE 702 does not receive the TCI activation MAC CE 722 that indicates the active TCI state of the CORESET (in which the type-1 CSS is configured) is associated with the additional PCI in time for the UE 702 to monitor the RAR window for the RAR 724, and if the UE 702 is predefined or configured to not monitor the CSS set associated with the serving cell PCI 704 or SpCell PCI 708 in the CORESET if the active TCI state is associated with the serving cell PCI 704 or SpCell PCI 708, the UE 702 may consider the reception of the RAR 724 unsuccessful. In one aspect, the UE 702 may increment a PRACH transmission counter.

In one aspect, if the UE 702 does not receive the TCI activation MAC CE 722 that indicates the active TCI state of the CORESET (in which the type-1 CSS is configured) is associated with the additional PCI in time for the UE 702 to monitor the RAR window for the RAR 724, and if the UE 702 is predefined or configured to monitor the CSS set associated with the serving cell PCI 704 or SpCell PCI 708 in the CORESET if the active TCI state is associated with the serving cell PCI 704 or the SpCell PCI 708, the UE 702 may consider the reception of the RAR 724 unsuccessful if the UE 702 does not receive a RAR from both the serving cell PCI 704 or SpCell PCI 708 and the additional PCI 706. In one example, if the UE 702 receives a RAR associated with the additional PCI 706 from the serving cell PCI 704 or SpCell PCI 708 and not the additional PCI 706, the UE 702 may apply the received TA to an UL transmission associated with additional PCI 706. In another example, if the UE 702 does not receive the RAR 724 from the additional PCI 706, the UE 702 may consider the reception of the RAR unsuccessful. The UE 702 may ignore a RAR received from the serving cell PCI 704 or SpCell PCI 708. In some aspects the UE 702 may be configured to consider the reception of the RAR 724 unsuccessful if the UE 702 does not receive a RAR from both the serving cell PCI 704 or SpCell PCI 708 and the additional PCI 706. In some other aspects, the UE 702 may be configured to or consider the reception of the RAR 724 unsuccessful if the UE 702 does not receive the RAR 724 from the additional PCI 706.

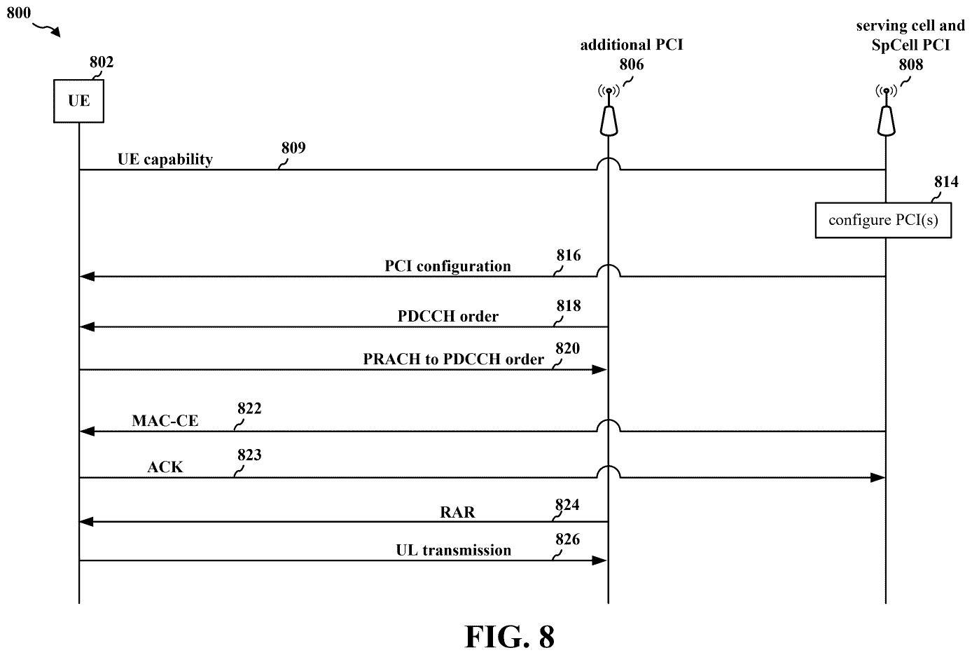

In FIG. 8, a connection flow diagram 800 illustrates an example of a wireless communications system having an additional PCI 806 configured to transmit a PDCCH order 818 to a UE 802. The serving cell PCI of the UE 802 may be the same as the SpCell PCI 808 of the UE 802. The additional PCI 806 may be a network node associated with the additional PCI of the UE 802, and the SpCell PCI 808 may be a network node associated with the special cell PCI of the UE 802. At 814, the SpCell PCI 808 may configure one or more PCIs for the UE 802, and may output a PCI configuration 816 to the UE 802. The UE 802 may receive the PCI configuration 816 of one or more PCIs for the UE 802 from the SpCell PCI 808. The PCI configuration 816 may configure, for example, the SpCell PCI 808 and the additional PCI 806 for the UE 802. The PCI configuration 816 may be, for example, an RRC configuration of the UE 802.

The additional PCI 806 may transmit a PDCCH order 818 to the UE 802, triggering the PRACH transmission 820 to the PDCCH order 818. In some example, the PDCCH order may be transmitted from SpCell PCI 808 which is not shown here. The additional PCI 806 may measure a timing advance (TA) for the UE 802 based on the PRACH transmission 820. In some aspects, the UE 802 may be configured to monitor CSS in a CORESET if the active TCI state is associated with a PCI different from the SpCell PCI 808. The CSS may be, for example, NR Type-1 CSS. The UE 802 may be configured to monitor CSS in a CORESET if the active TCI state is associated with the additional PCI 806. The UE 802 may be configured to monitor CSS in the CORESET if the active TCI state is associated with the additional PCI 806 in response to a MAC-CE received from the SpCell PCI 808. The SpCell PCI 808 may output the MAC-CE 822 to the UE 802. The UE 802 may receive the MAC-CE 822. The UE 802 may respond with an ACK 823 to the SpCell PCI 808. The SpCell PCI 808 may obtain the ACK 823 from the UE 802. The UE 802 may transmit an UL transmission 826 to the additional PCI using the measured TA. While one additional PCI 806 is shown in connection flow diagram 800, more additional PCIs may be configured with the UE 802 in other embodiments, as the PCI configuration 816 may include RRC configuration for a plurality of PCIs, depending upon the UE capability of the UE 802.

In one aspect, one CSS set may be configured in a CORESET and may be applied for the SpCell PCI 808 and the additional PCI 806. The configuration may be, for example, the PCI configuration 816 configured by the SpCell PCI 808 at 814. The active TCI state of the CORESET in which the CSS set is configured may be associated with the SpCell PCI 808 or the additional PCI 806 based on one or more indicators of the MAC-CE 822. In some aspects, the UE 802 may be configured to monitor the CSS in a CORESET if the active TCI state is associated with the additional PCI 806 within the RAR window associated with the additional PCI 806 and the additional PCI 806 is configured by the SpCell PCI 808 at 814. The UE 802 may determine that the additional PCI 806 is configured by the SpCell PCI 808 at 814 by receiving the PCI configuration 816 that configures the additional PCI 806 from the SpCell PCI 808.

The UE 802 may be configured to monitor CSS in a CORESET associated with the additional PCI 806 if the additional PCI 806 that the active TCI state of the CORESET is associated with is the same as the additional PCI 806 to which the PRACH transmission 820 or the RAR window of the RAR 824 corresponds. In other words, in response to the PRACH transmission 820 having a preamble ID that is indicated by the PDSCH of the RAR 824, the UE 802 may monitor CSS in a CORESET associated with the additional PCI 806. The PRACH transmission 820 and the RAR 824 may correspond with one another via the preamble ID indicated by the PDSCH.

The UE 802 may transmit a UE capability 809 to the SpCell PCI 808. The UE capability may have an indicator that indicates whether the UE 802 may monitor CSS in a CORESET if the active TCI state is associated with the additional PCI 806. In some aspects, the UE capability of the UE 802 may be configured in an RRC configuration, for example by the PCI configuration 816. The RRC configuration may be applied to the additional PCI 806 and no other additional PCIs, or to a set of additional PCIs, to which the additional PCI 806 belongs.

In some aspects, the UE 802 may be configured to determine whether to monitor CSS in a CORESET if the active TCI state is associated with the SpCell PCI 808. In one aspect, the UE 802 may be configured to not monitor CSS in the RAR window associated with the additional PCI 806 in a CORESET if the active TCI state is associated with the SpCell PCI 808. In another aspect, the UE 802 may be configured to monitor CSS in the RAR window associated with the additional PCI 806 in a CORESET if the active TCI state is associated with the SpCell PCI 808. In another aspect, the UE 802 may be configured to monitor CSS in the RAR window associated with the additional PCI 806 in a CORESET based on an RRC configuration, such as the PCI configuration 816. In one aspect, the RRC configuration may enable or disable CSS monitoring in the RAR window associated with a set of additional PCIs, which the additional PCI 806 is a part of. In another aspect, the RRC configuration may enable or disable CSS monitoring in the RAR window associated with the additional PCI 806 based on the configuration of the specific PCI value of the additional PCI 806. Each additional PCI 806 may be enabled or disabled based on individual triggers, such as MAC-CE tailored for each additional PCI. In one aspect, the UE 802 may be configured to monitor CSS in the RAR window associated with the additional PCI 806 when the active TCI state is associated with the SpCell PCI 808, but may not be configured to monitor CSS in the RAR window associated with a second additional PCI in a CORESET when the active TCI state is associated with the SpCell PCI 808. Such an aspect may be useful if there is a mixed backhaul scenario, for example when the backhaul between the SpCell PCI 808 and the additional PCI 806 has a good performance and the backhaul between the SpCell PCI 808 and the second additional PCI does not have a good performance.

In one aspect, a first CSS set may be configured in a CORESET for the SpCell PCI 808 and a second CSS set may be configured in the CORESET for the additional PCI 806. The configuration may be, for example, the PCI configuration 816 configured by the SpCell PCI 808 at 814. At 814, the SpCell PCI 808 may configure the second CSS associated with the additional PCI 806 and the additional PCI 806 via the PCI configuration 816. The active TCI state of the CORESET in which the CSS set is configured may be associated with the additional PCI 806 based on one or more indicators of the MAC-CE 822. The UE 802 may determine that the additional PCI 806 is configured by the SpCell PCI 808 at 814 by receiving the PCI configuration 816 that configures the additional PCI 806 from the SpCell PCI 808.

In some aspects, the UE 802 may be configured to monitor the CSS set in a CORESET associated with the serving cell PCI if the active TCI state is associated with the SpCell PCI 808. The UE 802 may be configured to monitor the CSS set in a CORESET associated with the additional PCI 806 if the active TCI state is associated with the additional PCI 806. The additional PCI may be the additional PCI to which the PRACH transmission 820 or the RAR 824 corresponds. In this aspect, the RAR for the PRACH transmission 820 associated with the SpCell PCI 808 may be transmitted from the SpCell PCI 808. The RAR for the PRACH transmission 820 associated with the additional PCI 806 may not be transmitted by a network node that is not the additional PCI 806. This configuration may be RRC configured to specifically the additional PCI 806 or to a set of additional PCIs to which the additional PCI 806 belongs. The UE capability 809 may have an indicator of whether the UE 802 may monitor the CSS set in a CORESET associated with the additional PCI 806 from the SpCell PCI 808. The UE capability 809 may have an indicator of whether the UE 802 may monitor the CSS set in a CORESET associated with the SpCell PCI 808 when the active TCI state is associated with the additional PCI 806.

In some aspects, the UE 802 may be configured to monitor the CSS set in a CORESET associated with the serving cell PCI if the active TCI state is associated with the SpCell PCI 808. The UE 802 may be configured to monitor the CSS set in a CORESET associated with the additional PCI 806 and associated with the serving cell PCI if the active TCI state is associated with the additional PCI 806. The additional PCI may be the additional PCI to which the PRACH transmission 820 or the RAR 824 corresponds. In this aspect, the RAR for the PRACH transmission 820 associated with the SpCell PCI 808 may be transmitted from the SpCell PCI 808 and not the additional PCI 806 or the SpCell PCI 808. The RAR for the PRACH transmission 820 associated with the additional PCI 806 may be transmitted by the SpCell PCI 808 or the additional PCI 806. This configuration may be RRC configured to specifically the additional PCI 806 or to a set of additional PCIs to which the additional PCI 806 belongs.

In some aspects, the UE 802 may be configured to monitor the CSS set in a CORESET associated with the additional PCI 806 and associated with the serving cell PCI regardless of whether the active TCI state is associated with the additional PCI 806 or associated with the SpCell PCI 808. In this aspect, the RAR for the PRACH transmission 820 associated with the SpCell PCI 808 or the RAR for the PRACH transmission 820 associated with the additional PCI 806 may be transmitted by the SpCell PCI 808 or the additional PCI 806. This configuration may be RRC configured to specifically the additional PCI 806 or to a set of additional PCIs to which the additional PCI 806 belongs.

In one aspect, the UE 802 may be configured to monitor CSS in a CORESET associated with the additional PCI 806 or monitor CSS in a CORESET associated with the SpCell PCI 808. In other words, the first CSS may be in a first CORESET associated with the additional PCI 806 and the second CSS may be in a second CORESET associated with the SpCell PCI 808. The UE 802 may be configured to monitor a RAR window based on the CORESET. The RAR window for a PRACH associated with the additional PCI 806 may be determined based on the CORESET that is configured with the additional CSS set or with the additional PCI 806. The RAR window for the PRACH transmission 820 associated with the additional PCI 806 may start at the first symbol of the earliest CORESET the UE 802 is configured to receive the CSS in the CORESET associated with the additional PCI 806. In other words, the RAR window may start a fixed number of symbols after the last symbol of the PRACH occasion corresponding to the PRACH transmission 820. For a CORESET associated with the SpCell PCI 808, the UE 802 may not expect the active TCI state of the CORESET that is associated with the additional PCI 806. In one aspect, for the CORESET associated with the additional PCI 806, the UE 802 may not expect the active TCI state of the CORESET to be associated with the SpCell PCI 808. In another aspect, for the CORESET associated with the additional PCI 806, the active TCI state of the CORESET may be associated with the SpCell PCI 808 or the additional PCI 806.

In one aspect, the UE 802 may be configured to monitor CSS associated with the additional PCI 806 in a CORESET when the active TCI state is associated with the additional PCI 806. The RAR 824 may be transmitted from the additional PCI 806 and may not be transmitted from the SpCell PCI 808 or the SpCell PCI 808. This configuration may be RRC configured to specifically the additional PCI 806 or to a set of additional PCIs to which the additional PCI 806 belongs.

In another aspect, the UE 802 may be configured to monitor CSS associated with the additional PCI 806 in a CORESET regardless of whether the active TCI state is associated with the additional PCI 806 or the SpCell PCI 808. The RAR 824 may be transmitted from the SpCell PCI 808 or the additional PCI 806. This configuration may be RRC configured to specifically the additional PCI 806 or to a set of additional PCIs to which the additional PCI 806 belongs.

In another aspect, the UE 802 may be configured to monitor CSS associated with the additional PCI 806 in a first CORESET associated with the additional PCI 806 or CSS associated with the SpCell PCI 808 in a second CORESET associated with the SpCell PCI 808. The UE 802 may monitor the CSS associated with the additional PCI 806 in a first CORESET associated with the additional PCI 806 if the active TCI state of the first CORESET is associated with the additional PCI 806. The UE 802 may monitor the CSS associated with the additional PCI 806 in a first CORESET associated with the additional PCI 806 regardless of whether the active TCI state is associated with the SpCell PCI 808 or the additional PCI 806. The RAR 824 may be transmitted by the additional PCI 806 or the SpCell PCI 808. This configuration may be RRC configured to specifically the additional PCI 806 or to a set of additional PCIs to which the additional PCI 806 belongs.

In some aspects, the TCI activation selected by the MAC-CE 822 may not be received by the UE 802 in time for the UE 802 to monitor the RAR window for the RAR 824. In some aspects, the TCI activation selected by the MAC-CE 822 may not be activated by the UE 802 in time for the UE 802 to monitor the RAR window for the RAR 824. In one aspect, if the UE 802 does not activate the TCI in time for the UE 802 to monitor the RAR window for the RAR 824, the UE 802 may transmit an indication of the error in the ACK 823. For example, the UE 802 may transmit a time period offset in the ACK 823 that corresponds to a delay in monitoring the RAR window. In response, the SpCell PCI 808 may indicate to the additional PCI 806 to ensure that the RAR 824 ca be transmitted from the additional PCI 806 within the new RAR window. In some aspects, the additional PCI 806 may receive the ACK 823 and apply the corresponding time period offset.

In one aspect, if the UE 802 does not activate the TCI in time for the UE 802 to monitor the RAR window for the RAR 824, the UE 802 may not monitor the CSS set associated with the SpCell PCI 808 in the CORESET if the active TCI state is associated with the SpCell PCI 808. The UE 802 may not consider the reception of the RAR 824 successful. The UE 802 may transmit a NACK in the UL transmission 826 to the additional PCI 806, which may act as a request to retransmit the RAR 824. In one aspect, the UE 802 may increment a transmission counter.

In one aspect, if the UE 802 does not activate the TCI in time for the UE 802 to monitor the RAR window for the RAR 824, the UE 802 may monitor the CSS set associated with the SpCell PCI 808 in the CORESET if the active TCI state is associated with the SpCell PCI 808. The UE 802 may not consider the reception of the RAR 824 successful if the UE 802 does not receive a RAR from both the SpCell PCI 808 and the additional PCI 806. If the UE 802 receives a RAR from the SpCell PCI 808 and not the additional PCI 806, the UE 802 may apply the received TA to an UL transmission to the SpCell PCI 808. If the UE 802 does not receive the RAR 824 from the additional PCI 806, the UE 802 may not consider the reception of the RAR successful. The UE 802 may ignore a RAR received from the SpCell PCI 808. In some aspects the UE 802 may be configured to toggle between not considering the reception of the RAR 824 successful if the UE 802 does not receive a RAR from both the SpCell PCI 808 and the additional PCI 806 or not considering the reception of the RAR 824 successful if the UE 802 does not receive the RAR 824 from the additional PCI 806. The SpCell PCI 808 may be configured to toggle the UE 802 between the two aspects by transmitting an indication in the MAC-CE 822 to select one aspect or the other.

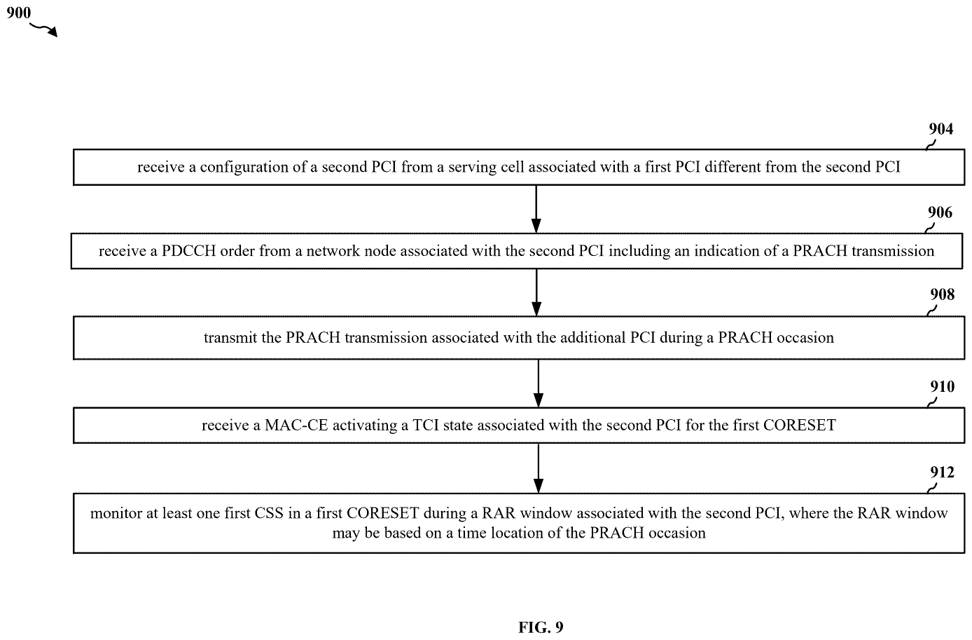

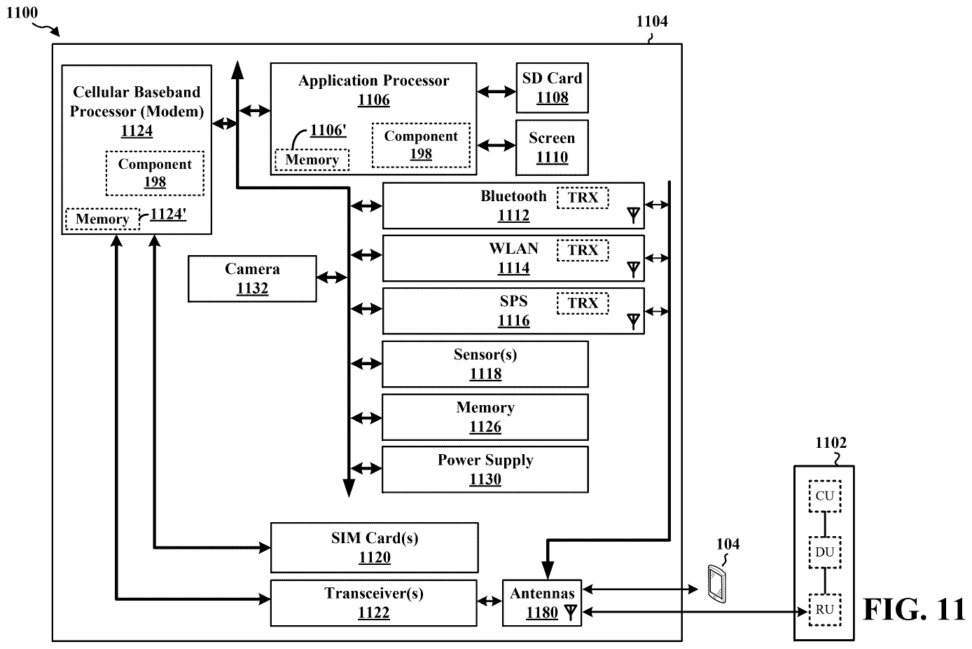

FIG. 9 is a flowchart 900 of a method of wireless communication. The method may be performed by a UE (e.g., the UE 104, the UE 350, the UE 430, the UE 702, the UE 802; the apparatus 1104). At 904, the UE may receive a configuration of a second PCI from a serving cell associated with a first PCI different from the second PCI. For example, 904 may be performed by the UE 702 in FIG. 7, which may receive a configuration of a second PCI as the PCI configuration 712 from the serving cell PCI 704 or the PCI configuration 716 from the SpCell PCI 708. The serving cell PCI 704 may be associated with a PCI different from the PCI of the additional PCI 706. The SpCell PCI 708 may be associated with a PCI different from the PCI of the additional PCI 706. Moreover, 904 may be performed by the component 198 of the apparatus 1104 in FIG. 11.

At 906, the UE may receive a PDCCH order from a network node associated with the second PCI including an indication of a PRACH transmission. In some aspects, the PDCCH order may be received from the serving cell PCI 704 or from SpCell PCI 708 which is not shown here. For example, 906 may be performed by the UE 702 in FIG. 7, which may receive a PDCCH order 718 from the additional PCI 706. The PDCCH order 718 may be associated with an indication of the PRACH transmission 720. Moreover, 906 may be performed by the component 198 of the apparatus 1104 in FIG. 11.

At 908, the UE may transmit the PRACH transmission associated with the additional PCI in a PRACH occasion. For example, 908 may be performed by the UE 702 in FIG. 7, which may transmit the PRACH transmission 720 associated with the additional PCI 706 in a PRACH occasion. Moreover, 908 may be performed by the component 198 of the apparatus 1104 in FIG. 11.

At 910, the UE may receive a MAC-CE activating a TCI state associated with the second PCI for the first CORESET. For example, 910 may be performed by the UE 702 in FIG. 7, which may receive a MAC-CE 722 from serving cell PCI 704. The MAC-CE may activate a TCI state associated with the second PCI for the first CORESET. Moreover, 910 may be performed by the component 198 of the apparatus 1104 in FIG. 11.

At 912, the UE may monitor at least one first CSS in a first CORESET during a RAR window associated with the second PCI. The RAR window may be based on a time location of the PRACH occasion. For example, 912 may be performed by the UE 702 in FIG. 7, which may monitor at least one first CSS in a first CORESET during a RAR window associated with the additional PCI 706. Moreover, 912 may be performed by the component 198 of the apparatus 1104 in FIG. 11.

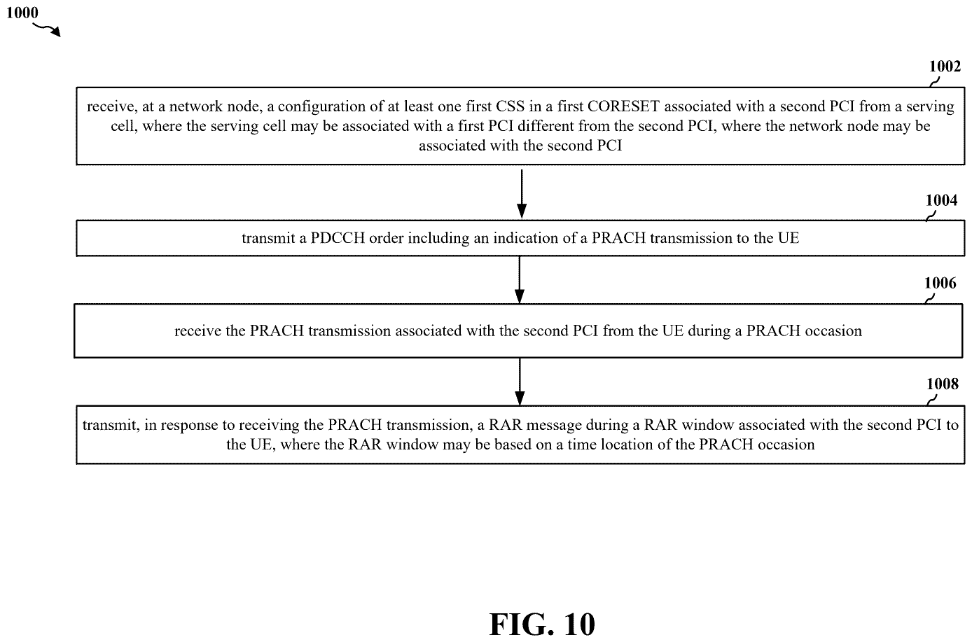

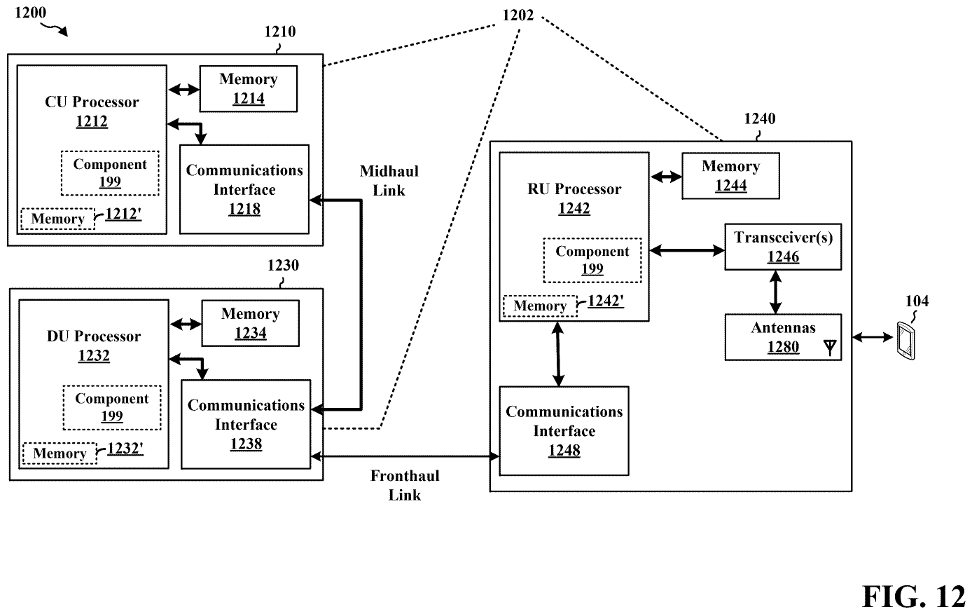

FIG. 10 is a flowchart 1000 of a method of wireless communication. The method may be performed by a network node (e.g., the base station 102, the base station 310; the TRP 410, the TRP 420, the additional PCI 706, the additional PCI 806; the network entity 1102, the network entity 1202). At 1002, the network node may receive a configuration of at least one first CSS in a first CORESET associated with a second PCI from a serving cell. The serving cell may be associated with a first PCI different from the second PCI. The network node may be associated with the second PCI. For example, 1002 may be performed by the additional PCI 706, which may receive a PCI configuration 713 from the serving cell PCI 704 and/or the SpCell PCI 708. The configuration may be received via inter-TRP communication or coordination. The PCI configuration 713 may define at least one first CSS in a first CORESET associated with a PCI of the additional PCI. The PCI of the serving cell PCI 704 may be different from the PCI of the additional PCI 706. The PCI of the SpCell PCI 708 may be different from the PCI of the additional PCI 706. The additional PCI 706 may be associated with the additional PCI of the PCI configuration 713. Moreover, 1002 may be performed by the component 199 of the network entity 1202 in FIG. 12.

At 1004, the network node may transmit a PDCCH order including an indication of a PRACH transmission to the UE. For example, 1004 may be performed by the additional PCI 706, which may transmit a PDCCH order 718 to the UE 702. The PDCCH order 718 may include an indication of the PRACH transmission 720. Moreover, 1004 may be performed by the component 199 of the network entity 1202 in FIG. 12.

At 1006, the network node may receive the PRACH transmission associated with the second PCI from the UE during a PRACH occasion. For example, 1006 may be performed by the additional PCI 706, which may receive the PRACH transmission 720 from the UE 702 during a PRACH occasion. Moreover, 1006 may be performed by the component 199 of the network entity 1202 in FIG. 12.

At 1008, the network node may transmit, in response to receiving the PRACH transmission, a RAR message during a RAR window associated with the second PCI to the UE. The RAR window may be based on a time location of the PRACH occasion. For example, 1008 may be performed by the additional PCI 706, which may transmit a RAR 724 during a RAR window associated with the additional PCI 706 to the UE 702. The transmission may be in response to receiving the PRACH transmission 720. The RAR window may be based on a time location of the PRACH occasion of the PRACH transmission 720. For example, the RAR window may be located 5 ms after the end of the PRACH occasion of the PRACH transmission 720. Moreover, 1008 may be performed by the component 199 of the network entity 1202 in FIG. 12.

FIG. 11 is a diagram 1100 illustrating an example of a hardware implementation for an apparatus 1104. The apparatus 1104 may be a UE, a component of a UE, or may implement UE functionality. In some aspects, the apparatus 1104 may include a cellular baseband processor 1124 (also referred to as a modem) coupled to one or more transceivers 1122 (e.g., cellular RF transceiver). The cellular baseband processor 1124 may include on-chip memory 1124′. In some aspects, the apparatus 1104 may further include one or more subscriber identity modules (SIM) cards 1120 and an application processor 1106 coupled to a secure digital (SD) card 1108 and a screen 1110. The application processor 1106 may include on-chip memory 1106′. In some aspects, the apparatus 1104 may further include a Bluetooth module 1112, a WLAN module 1114, an SPS module 1116 (e.g., GNSS module), one or more sensor modules 1118 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), memory 1126, a power supply 1130, and/or a camera 1132. The Bluetooth module 1112, the WLAN module 1114, and the SPS module 1116 may include an on-chip transceiver (TRX) (or in some cases, just a receiver (RX)). The Bluetooth module 1112, the WLAN module 1114, and the SPS module 1116 may include their own dedicated antennas and/or utilize the antennas 1180 for communication. The cellular baseband processor 1124 communicates through the transceiver(s) 1122 via one or more antennas 1180 with the UE 104 and/or with an RU associated with a network entity 1102. The cellular baseband processor 1124 and the application processor 1106 may each include a computer-readable medium/memory 1124′, 1106′, respectively. The memory 1126 may also be considered a computer-readable medium/memory. Each computer-readable medium/memory 1124′, 1106′, 1126 may be non-transitory. The cellular baseband processor 1124 and the application processor 1106 are each responsible for general processing, including the execution of software stored on the computer-readable medium/memory. The software, when executed by the cellular baseband processor 1124/application processor 1106, causes the cellular baseband processor 1124/application processor 1106 to perform the various functions described supra. The computer-readable medium/memory may also be used for storing data that is manipulated by the cellular baseband processor 1124/application processor 1106 when executing software. The cellular baseband processor 1124/application processor 1106 may be a component of the UE 350 and may include the memory 360 and/or at least one of the TX processor 368, the RX processor 356, and the controller/processor 359. In one configuration, the apparatus 1104 may be a processor chip (modem and/or application) and include just the cellular baseband processor 1124 and/or the application processor 1106, and in another configuration, the apparatus 1104 may be the entire UE (e.g., see UE 350 of FIG. 3) and include the additional modules of the apparatus 1104.

As discussed supra, the component 198 is configured to receive a first RRC configuration including a first configuration of a first PCI and a second PCI from a serving cell. The serving cell may be associated with a first PCI and an additional cell may be associated with the second PCI different from the first PCI. The component 198 may be configured to receive a PDCCH order from a network node including an indication of a PRACH transmission associated with the second PCI. The component 198 may be configured to transmit the PRACH transmission associated with the second PCI during a PRACH occasion. The component 198 may be configured to monitor at least one first CSS in a first CORESET during a RAR window associated with the second PCI. The RAR window may be based on a time location of the PRACH occasion. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1104 may include a variety of components configured for various functions. In one configuration, the apparatus 1104, and in particular the cellular baseband processor 1124 and/or the application processor 1106, includes means for receiving a configuration of a second PCI from a serving cell associated with a first PCI different from the second PCI. The apparatus 1104 may include means for monitoring at least one first CSS in a first CORESET during a RAR window associated with the second PCI. The apparatus 1104 may include means for transmitting the PRACH transmission based on the PDCCH order. The RAR window may be based on a timing of the PRACH transmission. The apparatus 1104 may include means for receiving a PDCCH order from a network node associated with the second PCI including an indication of a PRACH transmission. The apparatus 1104 may include means for receiving an RRC configuration from the serving cell including a set of TCI states associated with the first CORESET. The apparatus 1104 may include means for receiving MAC-CE including a selection of the first TCI state as an active TCI state from the first TCI state and the second TCI state. The apparatus 1104 may include means for monitoring the at least one first CSS in the first CORESET during the RAR window in response to the active TCI state being associated with the second PCI different from the first PCI. The apparatus 1104 may include means for monitoring the at least one first CSS in the first CORESET during the RAR window in response to (a) the active TCI state being associated with the second PCI different from the first PCI, (b) the SpCell serving the UE configuring the second PCI, and (c) the second PCI being associated with a CORESETPoolIndex for the serving cell and the SpCell or associated with a timing advance group (TAG) TAG ID for the serving cell and the SpCell. The apparatus 1104 may include means for transmitting a UE capability including a first indicator of a capability to monitor the at least one first CSS in the first CORESET when the active TCI state is associated with the second PCI. The apparatus 1104 may include means for receiving a MAC-CE including a selection of an active TCI state from the first TCI state and the second TCI state. The apparatus 1104 may include means for receiving an RRC configuration including a second indicator to activate the capability to monitor the at least one first CSS in the first CORESET when the active TCI state is associated with the second PCI. The apparatus 1104 may include means for monitoring the at least one first CSS in the first CORESET during the RAR window in response to the selection indicating the first TCI state as the active TCI state. The apparatus 1104 may include means for refraining from monitoring the at least one first CSS in the first CORESET during the RAR window in response to the selection indicating the second TCI state as the active TCI state. The apparatus 1104 may include means for receiving an RRC configuration including an indicator to enable monitoring the at least one first CSS in the first CORESET during the RAR window. The apparatus 1104 may include means for monitoring the at least one first CSS in the first CORESET during the RAR window in response to the RRC configuration including the indicator to enable monitoring the at least one first CSS in the first CORESET during the RAR window. The apparatus 1104 may include means for transmitting a UE capability including a first indicator of a capability to monitor the at least one first CSS in the first CORESET when the SpCell configures the at least one first CSS in the first CORESET. The apparatus 1104 may include means for refraining from monitoring the at least one first CSS in the first CORESET during the RAR window associated with at least one other second PCI. The apparatus 1104 may include means for receiving a MAC-CE including a selection of an active TCI state from the first TCI state and the second TCI state. The apparatus 1104 may include means for monitoring the at least one first CSS in the first CORESET during the RAR window in response to the selection indicating the first TCI state as the active TCI state. The apparatus 1104 may include means for refraining from monitoring the at least one first CSS in the first CORESET during the RAR window in response to the selection indicating the second TCI state as the active TCI state. The apparatus 1104 may include means for receiving a MAC-CE including a selection of an active TCI state from the first TCI state and the second TCI state. The apparatus 1104 may include means for monitoring the at least one first CSS in the first CORESET during the RAR window and during a second RAR window associated with the first PCI in response to the selection indicating the first TCI state as the active TCI state. The apparatus 1104 may include means for refraining from monitoring the at least one first CSS in the first CORESET during the RAR window in response to the selection indicating the second TCI state as the active TCI state. The apparatus 1104 may include means for monitoring the at least one first CSS in the first CORESET during the RAR window and during a second RAR window associated with the first PCI. The apparatus 1104 may include means for receiving a MAC-CE including a selection of an active TCI state from the first TCI state and the second TCI state. The apparatus 1104 may include means for transmitting a UE capability including a first indicator of a capability to monitor the at least one first CSS in the first CORESET when the active TCI state is associated with the second PCI. The apparatus 1104 may include means for receiving an RRC configuration including a first indicator of the first TCI state being associated with the at least one first CSS in the first CORESET and the second PCI and a second indicator of the second TCI state being associated with the at least one second CSS in the second CORESET and the first PCI. The apparatus 1104 may include means for receiving a MAC-CE including a selection of the first TCI state as an active TCI state from the first TCI state and the second TCI state. The apparatus 1104 may include means for monitoring the at least one first CSS in the first CORESET during the RAR window in response to the RRC configuration including the first indicator of the first TCI state being associated with the at least one first CSS in the first CORESET and the second PCI and the selection indicating the first TCI state as the active TCI state. The apparatus 1104 may include means for receiving a MAC-CE including a selection of an active TCI state from the first TCI state and the second TCI state. The apparatus 1104 may include means for monitoring the at least one first CSS in at least one of the first CORESET or the second CORESET during the RAR window in response to the selection indicating the first TCI state as the active TCI state. The apparatus 1104 may include means for refraining from monitoring the at least one first CSS in at least one of the first CORESET or the second CORESET during the RAR window in response to the selection indicating the second TCI state as the active TCI state. The apparatus 1104 may include means for receiving a MAC-CE including a selection of the second TCI state as an active TCI state from the first TCI state and the second TCI state. The apparatus 1104 may include means for monitoring the at least one first CSS in the first CORESET during the RAR window associated with the second PCI and during a second RAR window associated with the first PCI. The apparatus 1104 may include means for receiving a RAR message during at least one of the RAR window associated with the second PCI and the second RAR window associated with the first PCI. The apparatus 1104 may include means for processing the RAR message in response to receiving the RAR message during the second RAR window associated with the first PCI. The apparatus 1104 may include means for refraining from processing the RAR message in response to receiving the RAR message during the second RAR window associated with the second PCI. The apparatus 1104 may include means for receiving a RAR message during at least one of the RAR window associated with the second PCI and the second RAR window associated with the first PCI. The apparatus 1104 may include means for processing the RAR message in response to receiving the RAR message during the RAR window associated with the second PCI. The apparatus 1104 may include means for refraining from processing the RAR message in response to receiving the RAR message during the second RAR window associated with the first PCI. The means may be the component 198 of the apparatus 1104 configured to perform the functions recited by the means. As described supra, the apparatus 1104 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 12 is a diagram 1200 illustrating an example of a hardware implementation for a network entity 1202. The network entity 1202 may be a BS, a component of a BS, or may implement BS functionality. The network entity 1202 may include at least one of a CU 1210, a DU 1230, or an RU 1240. For example, depending on the layer functionality handled by the component 199, the network entity 1202 may include the CU 1210; both the CU 1210 and the DU 1230; each of the CU 1210, the DU 1230, and the RU 1240; the DU 1230; both the DU 1230 and the RU 1240; or the RU 1240. The CU 1210 may include a CU processor 1212. The CU processor 1212 may include on-chip memory 1212′. In some aspects, the CU 1210 may further include memory 1214 and a communications interface 1218. The CU 1210 communicates with the DU 1230 through a midhaul link, such as an F1 interface. The DU 1230 may include a DU processor 1232. The DU processor 1232 may include on-chip memory 1232′. In some aspects, the DU 1230 may further include memory 1234 and a communications interface 1238. The DU 1230 communicates with the RU 1240 through a fronthaul link. The RU 1240 may include an RU processor 1242. The RU processor 1242 may include on-chip memory 1242′. In some aspects, the RU 1240 may further include memory 1244, one or more transceivers 1246, antennas 1280, and a communications interface 1248. The RU 1240 communicates with the UE 104. The on-chip memory 1212′, 1232′, 1242′ and the memory 1214, 1234, 1244 may each be considered a computer-readable medium/memory. Each computer-readable medium/memory may be non-transitory. Each of the processors 1212, 1232, 1242 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 is configured to receive a configuration of at least one first CSS in a first CORESET associated with a second PCI from a serving cell. The serving cell may be associated with a first PCI different from the second PCI. The network node may be associated with the second PCI. The component 199 may be configured to transmit a PDCCH order including an indication of a PRACH transmission to a UE. The component 199 may be configured to receive the PRACH transmission associated with the second PCI from the UE during a PRACH occasion. The component 199 may be configured to transmit, in response to receiving the PRACH transmission, a RAR message during a RAR window associated with the second PCI to the UE. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1202 may include a variety of components configured for various functions. In one configuration, the network entity 1202 includes means for receiving a configuration of at least one first CSS in a first CORESET associated with a second PCI from a serving cell associated with a first PCI different from the second PCI. The network entity 1202 may include means for transmitting a RAR message during a RAR window associated with the second PCI to a UE. The network entity 1202 may include means for transmitting a PDCCH order including an indication of a PRACH transmission to the UE. The network entity 1202 may include means for receiving the PRACH transmission based on the PDCCH order from the UE. The RAR window may be based on a timing of the PRACH transmission. The means may be the component 199 of the network entity 1202 configured to perform the functions recited by the means. As described supra, the network entity 1202 may include the TX processor 316, the RX processor 370, and the controller/processor 375. As such, in one configuration, the means may be the TX processor 316, the RX processor 370, and/or the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data.

The following aspects are illustrative only and may be combined with other aspects or teachings described herein, without limitation.

Aspect 1 is a method of wireless communication at a UE, where the method may include receiving a configuration of a second PCI from a serving cell associated with a first PCI different from the second PCI. The method may include monitoring at least one first CSS in a first CORESET during a RAR window associated with the second PCI.

Aspect 2 is the method of aspect 1, where the method may include receiving a PDCCH order from a network node associated with the second PCI including an indication of a PRACH transmission. The method may include transmitting the PRACH transmission based on the PDCCH order. The RAR window may be based on a timing of the PRACH transmission.

Aspect 3 is the method of aspect 2, where monitoring the at least one first CSS in the first CORESET during the RAR window associated with the second PCI may be in response to the second PCI being associated with the PRACH or the RAR window.

Aspect 4 is the method of any of aspects 1 to 3, where the method may include receiving an RRC configuration from the serving cell including a set of TCI states associated with the first CORESET.

Aspect 5 is the method of any of aspects 1 to 4, where the first CORESET may include a first TCI state associated with the at least one first CSS in the first CORESET and the second PCI. The first CORESET may include a second TCI state associated with the at least one first CSS in the first CORESET and the first PCI.

Aspect 6 is the method of aspect 5, where the method may include receiving MAC-CE including a selection of the first TCI state as an active TCI state from the first TCI state and the second TCI state.

Aspect 7 is the method of aspect 6, where the serving cell may include an SpCell serving the UE.

Aspect 8 is the method of aspect 7, where monitoring the at least one first CSS in the first CORESET during the RAR window may be in response to the active TCI state being associated with the second PCI different from the first PCI.

Aspect 9 is the method of aspect 6, where the serving cell may not include an SpCell serving the UE.

Aspect 10 is the method of aspect 9, where monitoring the at least one first CSS in the first CORESET during the RAR window may be in response to (a) the active TCI state being associated with the second PCI different from the first PCI, (b) the SpCell serving the UE configuring the second PCI, and (c) the second PCI being associated with a CORESETPoolIndex for the serving cell and the SpCell or associated with a timing advance group (TAG) TAG ID for the serving cell and the SpCell.

Aspect 11 is the method of any of aspects 1 to 10, where the method may include transmitting a UE capability including a first indicator of a capability to monitor the at least one first CSS in the first CORESET when the active TCI state is associated with the second PCI.

Aspect 12 is the method of aspect 11, where the method may include receiving an RRC configuration including a second indicator to activate the capability to monitor the at least one first CSS in the first CORESET when the active TCI state is associated with the second PCI.

Aspect 13 is the method of any of aspects 1 to 12, where the RRC configuration may be associated with a set of additional PCIs. The set of additional PCIs may include the second PCI.

Aspect 14 is the method of aspect 5, where the method may include receiving a MAC-CE including a selection of an active TCI state from the first TCI state and the second TCI state. Monitoring the at least one first CSS in the first CORESET during the RAR window may include monitoring the at least one first CSS in the first CORESET during the RAR window in response to the selection indicating the first TCI state as the active TCI state. Monitoring the at least one first CSS in the first CORESET during the RAR window may include refraining from monitoring the at least one first CSS in the first CORESET during the RAR window in response to the selection indicating the second TCI state as the active TCI state.

Aspect 15 is the method of aspect 5, where the method may include receiving an RRC configuration including an indicator to enable monitoring the at least one first CSS in the first CORESET during the RAR window. Monitoring the at least one first CSS in the first CORESET during the RAR window may include monitoring the at least one first CSS in the first CORESET during the RAR window in response to the RRC configuration including the indicator to enable monitoring the at least one first CSS in the first CORESET during the RAR window.

Aspect 16 is the method of aspect 15, where the RRC configuration may be associated with a set of additional PCIs. The set of additional PCIs may include the second PCI.

Aspect 17 is the method of aspect 15, where the method may include refraining from monitoring the at least one first CSS in the first CORESET during the RAR window associated with at least one other second PCI.

Aspect 18 is the method of any of aspects 1 to 17, where the first CORESET may include a first TCI state associated with the at least one first CSS in the first CORESET and the second PCI. The first CORESET may include a second TCI state associated with at least one second CSS in at least one of the first CORESET or a second CORESET and the first PCI.

Aspect 19 is the method of aspect 18, where the serving cell may include an SpCell serving the UE. The SpCell may configure the at least one first CSS in the first CORESET.

Aspect 20 is the method of aspect 19, where the method may include transmitting a UE capability including a first indicator of a capability to monitor the at least one first CSS in the first CORESET when the SpCell configures the at least one first CSS in the first CORESET.

Aspect 21 is the method of aspect 18, where the serving cell may not include an SpCell serving the UE. The SpCell may configure the second PCI. The second PCI may be associated with a CORESETPoolIndex for the serving cell and the SpCell or associated with a TAG ID for the serving cell and the SpCell. The SpCell may configure the at least one first CSS in the first CORESET.

Aspect 22 is the method of aspect 18, where the serving cell may not include an SpCell serving the UE. The serving cell may configure the second PCI. The SpCell may not configure the second PCI. The serving cell may configure the at least one first CSS in the first CORESET.

Aspect 23 is the method of aspect 18, where the method may include receiving a MAC-CE including a selection of an active TCI state from the first TCI state and the second TCI state. The second TCI state may be associated with the at least one second CSS in the first CORESET and the first PCI. Monitoring the at least one first CSS in the first CORESET during the RAR window may include monitoring the at least one first CSS in the first CORESET during the RAR window in response to the selection indicating the first TCI state as the active TCI state. Monitoring the at least one first CSS in the first CORESET during the RAR window may include refraining from monitoring the at least one first CSS in the first CORESET during the RAR window in response to the selection indicating the second TCI state as the active TCI state. Aspect 24 is the method of aspect 18, where the method may include receiving a MAC-CE including a selection of an active TCI state from the first TCI state and the second TCI state. The second TCI state may be associated with the at least one second CSS in the first CORESET and the first PCI. Monitoring the at least one first CSS in the first CORESET during the RAR window may include monitoring the at least one first CSS in the first CORESET during the RAR window and during a second RAR window associated with the first PCI in response to the selection indicating the first TCI state as the active TCI state. Monitoring the at least one first CSS in the first CORESET during the RAR window may include refraining from monitoring the at least one first CSS in the first CORESET during the RAR window in response to the selection indicating the second TCI state as the active TCI state.

Aspect 25 is the method of aspect 18, where monitoring the at least one first CSS in the first CORESET during the RAR window may include monitoring the at least one first CSS in the first CORESET during the RAR window and during a second RAR window associated with the first PCI. The second TCI state may be associated with the at least one second CSS in the first CORESET and the first PCI.

Aspect 26 is the method of aspect 18, where the method may include receiving a MAC-CE including a selection of an active TCI state from the first TCI state and the second TCI state. The method may include transmitting a UE capability including a first indicator of a capability to monitor the at least one first CSS in the first CORESET when the active TCI state is associated with the second PCI.

Aspect 27 is the method of aspect 18, where the method may include receiving an RRC configuration including a first indicator of the first TCI state being associated with the at least one first CSS in the first CORESET and the second PCI and a second indicator of the second TCI state being associated with the at least one second CSS in the second CORESET and the first PCI. The method may include receiving a MAC-CE including a selection of the first TCI state as an active TCI state from the first TCI state and the second TCI state. Monitoring the at least one first CSS in the first CORESET during the RAR window may include monitoring the at least one first CSS in the first CORESET during the RAR window in response to the RRC configuration including the first indicator of the first TCI state being associated with the at least one first CSS in the first CORESET and the second PCI and the selection indicating the first TCI state as the active TCI state.

Aspect 28 is the method of aspect 18, where the method may include receiving a MAC-CE including a selection of an active TCI state from the first TCI state and the second TCI state. Monitoring the at least one first CSS in the first CORESET during the RAR window may include monitoring the at least one first CSS in at least one of the first CORESET or the second CORESET during the RAR window in response to the selection indicating the first TCI state as the active TCI state. Monitoring the at least one first CSS in the first CORESET during the RAR window may include refraining from monitoring the at least one first CSS in at least one of the first CORESET or the second CORESET during the RAR window in response to the selection indicating the second TCI state as the active TCI state.

Aspect 29 is the method of any of aspects 1 to 28, where the first CORESET may include a first TCI state associated with the at least one first CSS in the first CORESET and the second PCI. The first CORESET may include a second TCI state associated with the at least one first CSS in at least one of the first CORESET or a second CORESET and the first PCI. The method may include receiving a MAC-CE including a selection of the second TCI state as an active TCI state from the first TCI state and the second TCI state. Monitoring the at least one first CSS in the first CORESET during the RAR window may include monitoring the at least one first CSS in the first CORESET during the RAR window associated with the second PCI and during a second RAR window associated with the first PCI.

Aspect 30 is the method of aspect 29, where the method may include receiving a RAR message during at least one of the RAR window associated with the second PCI and the second RAR window associated with the first PCI. The method may include processing the RAR message in response to receiving the RAR message during the second RAR window associated with the first PCI. The method may include refraining from processing the RAR message in response to receiving the RAR message during the second RAR window associated with the second PCI.

Aspect 31 is the method of aspect 19, where the method may include receiving a RAR message during at least one of the RAR window associated with the second PCI and the second RAR window associated with the first PCI. The method may include processing the RAR message in response to receiving the RAR message during the RAR window associated with the second PCI. The method may include refraining from processing the RAR message in response to receiving the RAR message during the second RAR window associated with the first PCI.

Aspect 32 is a method of wireless communication at a network node, where the method may include receiving a configuration of at least one first CSS in a first CORESET associated with a second PCI from a serving cell associated with a first PCI different from the second PCI. The method may include transmitting a RAR message during a RAR window associated with the second PCI to a UE.

Aspect 33 is the method of aspect 32, where the method may include transmitting a PDCCH order including an indication of a PRACH transmission to the UE. The method may include receiving the PRACH transmission based on the PDCCH order from the UE. The RAR window may be based on a timing of the PRACH transmission.

Aspect 34 is an apparatus for wireless communication, including: a memory; and at least one processor coupled to the memory and, based at least in part on information stored in the memory, the at least one processor is configured to implement any of aspects 1 to 33.

Aspect 35 is the apparatus of aspect 34, further including at least one of an antenna or a transceiver coupled to the at least one processor.

Aspect 36 is an apparatus for wireless communication including means for implementing any of aspects 1 to 33.

Aspect 37 is a computer-readable medium (e.g., a non-transitory computer-readable medium) storing computer executable code, where the code when executed by a processor causes the processor to implement any of aspects 1 to 33.

Aspect 38 is a method of wireless communication at a UE, where the method may include receiving a first radio resource control (RRC) configuration including a first configuration of a first physical cell identifier (ID) (PCI) and a second PCI from a serving cell. The serving cell may be associated with a first PCI and an additional cell is associated with the second PCI different from the first PCI. The method may include transmitting a physical random access channel (PRACH) transmission associated with the second PCI during a PRACH occasion. The method may include monitoring at least one first common search space (CSS) in a first control resource set (CORESET) during a random access response (RAR) window associated with the second PCI. The RAR window may be based on a time location of the PRACH occasion.

Aspect 39 is the method of aspect 38, where the method may include receiving a physical downlink control channel (PDCCH) order from a network node including an indication of the PRACH transmission associated with the second PCI.

Aspect 40 is the method of aspects 38 to aspect 39, where the method may include receiving a medium access control (MAC) control element (MAC-CE) including an indicator to activate a first TCI state associated with the second PCI for the first CORESET.

Aspect 41 is the method of any of aspects 38 to 40, where the serving cell may include an SpCell serving the UE.

Aspect 42 is the method of aspects 38 to 41, where monitoring the at least one first CSS in the first CORESET during the RAR window may include monitoring the at least one first CSS in the first CORESET during the RAR window in response to the active TCI state of the first CORESET being associated with the second PCI different from the first PCI.

Aspect 43 is the method of aspect 38, where the serving cell may be different from an SpCell serving the UE. The method may further include receiving a second RRC configuration including a second configuration of a third PCI different from the first PCI. The SpCell may be associated with the third PCI

Aspect 44 is the method of aspect 43, where monitoring the at least one first CSS in the first CORESET during the RAR window may include monitoring the at least one first CSS in the first CORESET during the RAR window in response to (a) the active TCI state being associated with the second PCI different from the first PCI, (b) the SpCell associated with a third PCI serving the UE configuring the second PCI, and (c) the second PCI being associated with a same CORESETPoolIndex for the serving cell and the SpCell or associated with a same TAG ID for the serving cell and the SpCell.

Aspect 45 is the method of aspects 38 to 44, where the method may include transmitting a UE capability including a first indicator of a capability to monitor the at least one first CSS in the first CORESET when the active TCI state is associated with the second PCI.

Aspect 46 is the method of aspect 45, where the first RRC configuration may include a second indicator to activate the capability to monitor the at least one first CSS in the first CORESET in response to the active TCI state being associated with the second PCI.

Aspect 47 is the method of any of aspects 38 to 46, where the first configuration may include a set of additional PCIs. The set of additional PCIs may include the second PCI.

Aspect 48 is the method of aspect 46, where the first configuration may include one additional PCI. The one additional PCI may be the second PCI.

Aspect 49 is the method of aspect 43, where the method may include refraining from monitoring the at least one first CSS in the first CORESET during the RAR window in response to an active TCI state of the first CORESET being associated with the third PCI.

Aspect 50 is the method of aspect 43, where the method may include monitoring the at least one first CSS in the first CORESET during the RAR window in response to the active TCI state of the first CORESET being associated with the third PCI associated with the SpCell.

Aspect 51 is the method of aspect 43, where the second RRC configuration may include an indicator to enable monitoring the at least one first CSS in the first CORESET during the RAR window in response to an active TCI state of the first CORESET being associated with the third PCI associated with the SpCell. Monitoring the at least one first CSS in the first CORESET during the RAR window may include monitoring the at least one first CSS in the first CORESET during the RAR window in response to (a) the second RRC configuration including the indicator to enable monitoring the at least one first CSS in the first CORESET during the RAR window and (b) an active TCI state of the first CORESET being associated with the third PCI.

Aspect 52 is the method of aspect 51, where the second RRC configuration may be associated with a set of additional PCIs. The set of additional PCIs may include the second PCI.

Aspect 53 is the method of aspect 51, where the second RRC configuration may be associated with one PCI. The one PCI may include the second PCI.

Aspect 54 is the method of aspects 38 to 53, where the method may include receiving a configuration of at least one second CSS in a second CORESET on a special cell (SpCell). The SpCell may be associated with a third PCI. The method may include receiving a configuration of the at least one first CSS in the first CORESET for a set of additional PCIs. The set of additional PCIs may include the second PCI. The first CSS may be different from the second CSS.

Aspect 55 is the method of aspect 54, where the serving cell may include a special cell (SpCell) serving the UE. The SpCell may configure the at least one first CSS in the first CORESET.

Aspect 56 is the method of aspect 54, where the serving cell may not include a special cell (SpCell) serving the UE. The SpCell may configure the second PCI. The SpCell may be associated with a third PCI different from the first PCI. The second PCI may be associated with a same CORESETPoolIndex for the serving cell and the SpCell or associated with a same timing advance group (TAG) ID for the serving cell and the SpCell. The SpCell may configure the at least one first CSS in the first CORESET

Aspect 57 is the method of aspect 54, where the serving cell may not include a special cell (SpCell) serving the UE. The serving cell may configure the second PCI. The SpCell may not configure the second PCI. The SpCell may be associated with a third PCI. The serving cell may configure the at least one first CSS in the first CORESET.

Aspect 58 is the method of aspect 54, where the second CORESET may be the same as the first CORESET.

Aspect 59 is the method of aspect 58, where the method may include monitoring the at least one first CSS in the first CORESET during the RAR window in response to a first active TCI state of the first CORESET being associated with the second PCI. The method may include refraining from monitoring the at least one second CSS in the second CORESET during the RAR window in response to a second active TCI state of the second CORESET being associated with the second PCI. The method may include monitoring the at least one second CSS in the second CORESET during the RAR window in response to the second active TCI state of the second CORESET being associated with the third PCI. The method may include refraining from monitoring the at least one first CSS in the first CORESET during the RAR window in response to the first active TCI state of the first CORESET being associated with the third PCI.

Aspect 60 is the method of aspect 58, where the method may include monitoring both the at least one first CSS in the first CORESET and the at least one second CSS in the second CORESET during the RAR window in response to a first active TCI state of the first CORESET and the second CORESET being associated with the second PCI. The method may include monitoring the second CSS in the second CORESET during the RAR window in response to a second active TCI state of the second CORESET being associated with the third PCI. The method may include refraining from monitoring the at least one first CSS in the first CORESET during the RAR window in response to the second active TCI state of the second CORESET being associated with the third PCI.

Aspect 61 is the method of aspect 58, where monitoring the at least one first CSS in the first CORESET during the RAR window may include monitoring both the at least one first CSS in the first CORESET and the second CSS in the second CORESET during the RAR window.

Aspect 62 is the method of aspect 54, where the second CORESET may be different from the first CORESET and the RAR window associated with the second PCI may be based on the first CORESET.

Aspect 63 is the method of aspect 62, where the method may include monitoring the at least one first CSS in the first CORESET during the RAR window in response to an active TCI state of the first CORESET being associated with the second PCI. The method may include refraining from monitoring the second CSS in the second CORESET during the RAR window.

Aspect 64 is the method of aspect 62, where the method may include monitoring at least one first CSS in the first CORESET during the RAR window in response to a first active TCI state of the second CORESET being associated with the first PCI or second PCI or in response to a second active TCI state of the second CORESET being associated with the second PCI or third PCI. The method may include refraining from monitoring the second CSS in the second CORESET during the RAR window.

Aspect 65 is the method of aspect 62, where the method may include monitoring both the at least one first CSS in the first CORESET and the second CSS in the second CORESET in the RAR window. Monitoring the at least one first CSS in the first CORESET may include monitoring the at least one first CSS in the first CORESET in response to an active TCI state of the first CORESET being associated with the second PCI. Monitoring the at least one first CSS in the first CORESET may include monitoring the at least one first CSS in the first CORESET in response to the active TCI state of the first CORESET being associated with the first PCI or the second PCI or in response to the active TCI state of the first CORESET being associated with the second PCI and the third PCI.

Aspect 66 is the method of aspects 38 to 65, where the method may include reporting the random access response as unsuccessful in response to at least one of (a) a failure to receive a medium access control (MAC) control element (MAC-CE) including an indicator to activate an active TCI state of the first CORESET (b) the second CORESET being associated with the second PCI or (c) not monitoring the at least one first CSS in the first CORESET in response to the active TCI state being associated with the first PCI or a third PCI associated with a special cell (SpCell).

Aspect 67 is the method of aspects 38 to 66, where the method may include receiving a RAR message during the RAR window associated with the second PCI. The method may include processing the RAR message in response to a failure to receive a medium access control (MAC) control element (MAC-CE) including an indicator to activate a TCI state of the first CORESET or the second CORESET associated with the second PCI.

Aspect 68 a method of wireless communication at a network node. The method may include receiving a configuration of at least one first common search space (CSS) in a first control resource set (CORESET) associated with a second physical cell identifier (ID) (PCI) from a serving cell. The serving cell may be associated with a first PCI different from the second PCI. The network node may be associated with the second PCI. The method may include receiving a physical random access channel (PRACH) transmission associated with the second PCI from the UE during a PRACH occasion. The method may include transmitting, in response to receiving the PRACH transmission, a random access response (RAR) message during a RAR window associated with the second PCI to the UE. The RAR window may be based on a time location of the PRACH occasion.

Aspect 69 is the method of aspect 68, where the method may include transmitting a physical downlink control channel (PDCCH) order including an indication of the PRACH transmission to the UE.

Aspect 70 is the method of any of aspects 68 to 69, where the method may include

Aspect 71 is an apparatus for wireless communication, including: a memory; and at least one processor coupled to the memory and, based at least in part on information stored in the memory, the at least one processor is configured to implement any of aspects 38 to 70.

Aspect 72 is the apparatus of aspect 71, further including at least one of an antenna or a transceiver coupled to the at least one processor.

Aspect 73 is an apparatus for wireless communication including means for implementing any of aspects 38 to 70.

Aspect 74 is a computer-readable medium (e.g., a non-transitory computer-readable medium) storing computer executable code, where the code when executed by a processor causes the processor to implement any of aspects 38 to 70.

What is claimed is:

1. An apparatus for wireless communication at a user equipment (UE), comprising:
a memory; and
at least one processor coupled to the memory and, based at least in part on information stored in the memory, the at least one processor is configured to:
receive a first radio resource control (RRC) configuration comprising a first configuration of a first physical cell identifier (ID) (PCI) and a second PCI from a serving cell, wherein the serving cell is associated with a first PCI and an additional cell is associated with the second PCI different from the first PCI;
transmit a physical random access channel (PRACH) transmission associated with the second PCI during a PRACH occasion; and
monitor at least one first common search space (CSS) in a first control resource set (CORESET) during a random access response (RAR) window associated with the second PCI, wherein the RAR window is based on a time location of the PRACH occasion.

2. The apparatus of claim 1, further comprising a transceiver coupled to the at least one processor, wherein the at least one processor is further configured to:
receive, via the transceiver, a physical downlink control channel (PDCCH) order from a network node comprising an indication of the PRACH transmission associated with the second PCI.

3. The apparatus of claim 1, wherein the serving cell comprises a special cell (SpCell).

4. The apparatus of claim 1, wherein, to monitor the at least one first CSS in the first CORESET during the RAR window, the at least one processor is further configured to monitor the at least one first CSS in the first CORESET during the RAR window in response to an active TCI state of the first CORESET being associated with the second PCI different from the first PCI.

5. The apparatus of claim 1, wherein the serving cell is different from a special cell (SpCell), wherein the at least one processor is further configured to:
receive a second RRC configuration comprising a second configuration of a third PCI different from the first PCI, wherein the SpCell is associated with the third PCI.

6. The apparatus of claim 5, wherein, to monitor the at least one first CSS in the first CORESET during the RAR window, the at least one processor is further configured to monitor the at least one first CSS in the first CORESET during the RAR window in response to (a) an active TCI state of the first CORESET being associated with the second PCI different from the first PCI, (b) the second RRC configuration comprising the second PCI, and (c) the second PCI being associated with a same CORESETPoolIndex for the serving cell and the SpCell or associated with a same timing advance group (TAG) TAG ID for the serving cell and the SpCell.

7. The apparatus of claim 1, wherein the at least one processor is further configured to:
transmit a UE capability comprising a first indicator of a capability to monitor the at least one first CSS in the first CORESET in response to an active TCI state of the first CORESET being associated with the second PCI.

8. The apparatus of claim 7, wherein the first RRC configuration comprises a second indicator to activate the capability to monitor the at least one first CSS in the first CORESET in response to the active TCI state being associated with the second PCI.

9. The apparatus of claim 1, wherein the first configuration further comprises a set of additional PCIs, wherein the set of additional PCIs comprises the second PCI.

10. The apparatus of claim 1, wherein the first configuration further comprises one additional PCI, wherein the one additional PCI comprises the second PCI.

11. The apparatus of claim 5, wherein the at least one processor is further configured to:
refrain from monitoring the at least one first CSS in the first CORESET during the RAR window in response to an active TCI state of the first CORESET being associated with the third PCI.

12. The apparatus of claim 5, wherein the at least one processor is further configured to:
monitor the at least one first CSS in the first CORESET during the RAR window in response to an active TCI state of the first CORESET being associated with the third PCI.

13. The apparatus of claim 5, wherein the second RRC configuration further comprises an indicator to enable monitoring the at least one first CSS in the first CORESET during the RAR window in response to an active TCI state of the first CORESET being associated with the third PCI associated with the SpCell, wherein, to monitor the at least one first CSS in the first CORESET during the RAR window, the at least one processor is further configured to:
monitor the at least one first CSS in the first CORESET during the RAR window in response to (a) the second RRC configuration comprising the indicator to enable monitoring the at least one first CSS in the first CORESET during the RAR window and (b) the active TCI state of the first CORESET being associated with the third PCI.

14. The apparatus of claim 1, wherein the at least one processor is further configured to:
receive a first configuration of at least one second CSS in a second CORESET on a special cell (SpCell), wherein the SpCell is associated with a third PCI; and
receive a second configuration of the at least one first CSS in the first CORESET for a set of additional PCIs, wherein the set of additional PCIs comprises the second PCI, wherein the first CSS is different from the second CSS.

15. The apparatus of claim 14, wherein the serving cell comprises the SpCell serving the UE, wherein the SpCell configures the at least one first CSS in the first CORESET.

16. The apparatus of claim 14, wherein the serving cell does not comprise the SpCell serving the UE, wherein the SpCell configures the second PCI, wherein the SpCell is associated with the third PCI different from the first PCI, wherein the second PCI is associated with a same CORESETPoolIndex for the serving cell and the SpCell or associated with a same timing advance group (TAG) ID for the serving cell and the SpCell, wherein the SpCell configures the at least one first CSS in the first CORESET.

17. The apparatus of claim 14, wherein the serving cell does not comprise the SpCell serving the UE, wherein the serving cell configures the second PCI, wherein the SpCell does not configure the second PCI, wherein the SpCell is associated with the third PCI, wherein the serving cell configures the at least one first CSS in the first CORESET.

18. The apparatus of claim 14, wherein the second CORESET is same as the first CORESET.

19. The apparatus of claim 18, wherein the at least one processor is further configured to:
monitor the at least one first CSS in the first CORESET during the RAR window in response to a first active TCI state of the first CORESET being associated with the second PCI;
refrain from monitoring the at least one second CSS in the second CORESET during the RAR window in response to a second active TCI state of the second CORESET being associated with the second PCI;
monitor the at least one second CSS in the second CORESET during the RAR window in response to the second active TCI state of the second CORESET being associated with the third PCI; and
refrain from monitoring the at least one first CSS in the first CORESET during the RAR window in response to the first active TCI state of the first CORESET being associated with the third PCI.

20. The apparatus of claim 18, wherein the at least one processor is further configured to:
monitor both the at least one first CSS in the first CORESET and the at least one second CSS in the second CORESET during the RAR window in response to a first active TCI state of the first CORESET and the second CORESET being associated with the second PCI;
monitor the second CSS in the second CORESET during the RAR window in response to a second active TCI state of the second CORESET being associated with the third PCI; and
refrain from monitoring the at least one first CSS in the first CORESET during the RAR window in response to the second active TCI state of the second CORESET being associated with the third PCI.

21. The apparatus of claim 18, wherein, to monitor the at least one first CSS in the first CORESET during the RAR window, the at least one processor is further configured to:
monitor both the at least one first CSS in the first CORESET and the second CSS in the second CORESET during the RAR window.

22. The apparatus of claim 14, wherein the second CORESET is different from the first CORESET and the RAR window associated with the second PCI is based on the first CORESET.

23. The apparatus of claim 22, wherein the at least one processor is further configured to:
monitor the at least one first CSS in the first CORESET during the RAR window in response to an active TCI state of the first CORESET being associated with the second PCI; and
refrain from monitoring the second CSS in the second CORESET during the RAR window.

24. The apparatus of claim 22, wherein the at least one processor is further configured to:
monitor at least one first CSS in the first CORESET during the RAR window in response to a first active TCI state of the second CORESET being associated with the first PCI or second PCI or in response to a second active TCI state of the second CORESET being associated with the second PCI or the third PCI; and
refrain from monitoring the second CSS in the second CORESET during the RAR window.

25. The apparatus of claim 22, wherein the at least one processor is further configured to:
monitor both the at least one first CSS in the first CORESET and the second CSS in the second CORESET in the RAR window, wherein,
to monitor the at least one first CSS in the first CORESET, the at least one processor is further configured to monitor the at least one first CSS in the first CORESET in response to an active TCI state of the first CORESET being associated with the second PCI, or
to monitor the at least one first CSS in the first CORESET, the at least one processor is further configured to monitor the at least one first CSS in the first CORESET in response to the active TCI state of the first CORESET being associated with the first PCI or the second PCI or in response to the active TCI state of the first CORESET being associated with the second PCI and the third PCI.

26. The apparatus of claim 1, wherein the at least one processor is further configured to:
receive a RAR message during the RAR window associated with the second PCI; and
process the RAR message in response to a failure to receive a medium access control (MAC) control element (MAC-CE) comprising an indicator to activate a TCI state of the first CORESET or the second CORESET associated with the second PCI.

27. An apparatus of wireless communication at a network node, comprising:
a memory; and
at least one processor coupled to the memory and, based at least in part on information stored in the memory, the at least one processor is configured to:
receive a configuration of at least one first common search space (CSS) in a first control resource set (CORESET) associated with a second physical cell identifier (ID) (PCI) from a serving cell, wherein the serving cell is associated with a first PCI different from the second PCI, wherein the network node is associated with the second PCI;
receive a physical random access channel (PRACH) transmission associated with the second PCI from a user equipment (UE) during a PRACH occasion; and
transmit, in response to receiving the PRACH transmission, a random access response (RAR) message during a RAR window associated with the second PCI to the UE, wherein the RAR window is based on a time location of the PRACH occasion.

28. The apparatus of claim 27, further comprising a transceiver coupled to the at least one processor, wherein the at least one processor is further configured to:
transmit, via the transceiver, a physical downlink control channel (PDCCH) order comprising an indication of the PRACH transmission to the UE.

29. A method of communication at a user equipment (UE), comprising:
receiving a first radio resource control (RRC) configuration comprising a first configuration of a first physical cell identifier (ID) (PCI) and a second PCI from a serving cell, wherein the serving cell is associated with a first PCI and an additional cell is associated with the second PCI different from the first PCI;
transmitting a physical random access channel (PRACH) transmission associated with the second PCI during a PRACH occasion; and
monitoring at least one first common search space (CSS) in a first control resource set (CORESET) during a random access response (RAR) window associated with the second PCI, wherein the RAR window is based on a time location of the PRACH occasion.

30. A method of communication at a network node, comprising:
transmitting a radio resource control (RRC) configuration of at least one first common search space (CSS) in a first control resource set (CORESET) associated with a second physical cell identifier (ID) (PCI) from a serving cell to a user equipment (UE), wherein the serving cell is associated with a first PCI different from the second PCI;
receiving a physical random access channel (PRACH) transmission associated with the second PCI from the UE during a PRACH occasion; and
transmitting in response to receiving the PRACH transmission, a random access response (RAR) message during a RAR window associated with the second PCI to the UE, wherein the RAR window is based on a time location of the PRACH occasion.
